(19) United States
(12) Patent Application Publication
(10) Pub. No.: US 2025/0035070 A1
(43) Pub. Date: Jan. 30, 2025

(54) HYBRID ROCKET ENGINE FUEL GRAINS WITH COMPOSITIONAL VARIATIONS

(71) Applicant: FIREHAWK AEROSPACE, INC., Carrollton, TX (US)

(72) Inventors: Ronald D. Jones, Denton, TX (US); Michael Joseph Baier, Garland, TX (US); Justin Otto Karl, Titusville, TX (US); Ben Giles, Euless, TX (US); Andrew Copeland, Plano, TX (US)

(21) Appl. No.: 18/717,599

(22) PCT Filed: Dec. 6, 2022
(86) PCT No.: PCT/US22/52021

§ 371 Date: Jun. 7, 2024

Related U.S. Application Data
(63) Continuation of application No. 17/544,236, filed on Dec. 7, 2021.
(63) Continuation of application No. 17/544,263, filed on Dec. 7, 2021.

(51) Int. Cl. F02K 9/10; F02K 9/12; F02K 9/14; F02K 9/18; F02K 9/72

(52) U.S. Cl. CPC F02K 9/10; F02K 9/12; F02K 9/14; F02K 9/72; F02K 9/18

(57) ABSTRACT

A fuel grain for a hybrid rocket engine includes multiple layers of fuel grain material defining a combustion port extending through a body of the fuel grain, in which each layer includes multiple beads of fuel grain material, in which the multiple beads in a given layer are disposed adjacent to one another and bonded together, and in which adjacent layers are bonded together, in which each bead of fuel grain material includes a polymer based rocket fuel material, and in which a composition of the beads of the fuel grain material, a form of the beads of fuel grain material, or both varies within the fuel grain.

### CLAIM OF PRIORITY

This application claims priority to U.S. patent application Ser. No. 17/544,236, filed on Dec. 7, 2021, and to U.S. patent application Ser. No. 17/544,263, filed on Dec. 7, 2021, the contents of both of which are incorporated here by reference in their entirety.

### BACKGROUND

There are various types of chemical rocket propulsion systems. Liquid rocket engines use liquid propellants. Solid rocket motors use solid propellants. Hybrid rocket engines use a combination of liquid and solid propellants. In a hybrid rocket engine, oxidizer is typically in liquid or vapor state and fuel is in solid or semi-solid state. The fuel is formed into a tubular shaped fuel grain with one or more ports that serve via pyrolization as the fuel source and as the engine's combustion chamber(s).

### SUMMARY

This document relates to fuel grains for hybrid rocket engines. The composition of the fuel grains described herein varies in formulation and energy release within the fuel grains, e.g., along a radius or axis of the fuel grains, around the circumference of the fuel grains, or in specific locations of the fuel grains. Using a vertically oriented or horizontally oriented additive manufacturing system and solid fuel materials of specific formulations, these fuel grains can be additively formed of fused beads, e.g., fused concentric beads of increasing radii. In both additive manufacturing systems (e.g. vertical and horizontal orientations), the fuel grain material includes a polymer based fuel material and an additive. For instance, the fuel grain material can be a polymer fuel material mixed (e.g., compounded) with metallic or polymer powder, or a polymer/nanoscale metallic blended material produced at the molecular level in a reactor to form a specific composition of solid fuel possessing a specific energetic release upon combustion. The composition of one or more of the concentric beads differ from the composition of the other beads in the fuel grain. For instance, the composition of the beads can vary from the inner port wall outward to the fuel grain's outer surface, e.g., such that the fuel grain has a radial variation in composition from the inner port wall toward the outer surface of the fuel grain. The compositional variation encompasses features such as the weight or volume percentage of the additive, the size or geometry of the additive, the composition of the additive, or the composition of the polymer fuel material. The compositional variation also encompasses features such as the local density of the fuel grain material, the size or geometry of the beads, or the presence of mesoscale voids or macroscale discontinuities in the fuel grain.

The fuel grains described herein are fabricated by additive manufacturing techniques, such as by extrusion and deposition of beads, e.g., concentric circular beads, of the fuel grain material to form concentric layers that are fusion stacked to form the fuel grain. In some examples, compositional variation is achieved by controlling an amount of the additive material blended in a liquid medium provided by a single injector under computer control upstream of the deposition head of an additive manufacturing system, e.g., a vertically or horizontally oriented additive manufacturing system. In some examples, compositional variation is achieved by depositing fuel grain materials of different energetic compositions from multiple, distinct deposition heads and nozzles of an additive manufacturing system, e.g., in which the build orientation is horizontal.

In a first aspect, a method of making a fuel grain for a hybrid rocket engine includes depositing beads of fuel grain material onto a mandrel using additive manufacturing to form a fuel grain, each bead including a polymer based rocket fuel material. The depositing includes depositing multiple, adjacent beads to form concentric layers of beads, wherein a composition of the beads of the fuel grain material differs between the beads of a first layer and the beads of a second layer of the fuel grain.

Embodiments can include one or any combination of two or more of the following features.

A composition of the polymer based rocket fuel material differs between the beads of the first layer and the beads of the second layer of the fuel grain.

At least some of the beads include a metallic or polymer additive material. In some cases, the method includes depositing the beads such that one or more of a weight percentage of the metallic or polymer additive material, a volume percentage of the metallic or polymer additive material, a shape of the metallic or polymer additive material, or a size of the metallic or polymer additive material in the beads of the fuel grain material differs between the beads of the first layer and the beads of the second layer of the fuel grain. In some cases, the method includes depositing the beads such that a composition of the metallic or polymer additive material differs between the beads of the first layer and the beads of the second layer of the fuel grain. In some cases, depositing multiple beads includes deposing beads including between 75% and 95% by weight of the polymer based rocket fuel material and between 5% and 25% by weight of the metallic or polymer additive material. In some cases, the metallic or polymer additive material includes nanoscale aluminum particles and in which the polymer based rocket fuel material includes an ABS thermoplastic. In some cases, the metallic or polymer additive material includes nanoscale or microscale metal or polymer particles. In some cases, the method includes depositing the beads such that the beads of an innermost one of the concentric layers have a greater weight percentage of the metallic or polymer additive material than the beads of an outermost one of the concentric layers. In some cases, the method includes depositing the beads such that the metallic or polymer additive material in the beads of the innermost one of the concentric layers is smaller in size than the metallic or polymer additive material in the beads of an outermost one of the concentric layers.

Depositing the beads of fuel grain material includes rotating the mandrel during deposition of the beads.

The method includes depositing the beads using a single deposition head. In some cases, at least some of the beads include a metallic or polymer additive material, and depositing each layer of beads includes changing an amount of the metallic or polymer additive material provided to the single deposition head between deposition of the beads of the first layer and deposition of the beads of the second layer. In some cases, changing the amount of the metallic or polymer additive material includes varying a rate at which the metallic or polymer additive material is injected into the hybrid rocket fuel material.

The method includes depositing the beads of the first layer using a first deposition head and depositing the beads of the second layer using a second deposition head. In some cases, the method includes supplying a first composition of fuel grain material to the first deposition head and a second composition of fuel grain material to the second deposition head.

The method includes encasing the fuel grain in a cover without removing the fuel grain from the mandrel. In some cases, the method includes rotating the mandrel to encase the fuel grain in the cover.

The method includes varying an extrusion rate of the fuel grain material during the depositing.

The method includes stopping the depositing to define a void in the fuel grain. In some cases, the method includes disposing a second material into the void. In some cases, the second material includes one or more of a solid propellant or a high thermal conductivity material. In some cases, the method includes disposing the second material into the void using a manufacturing technique other than the additive manufacturing used to depose the beads of the fuel grain material.

In a second aspect, combinable with the first aspect, a method of making a fuel grain for a hybrid rocket engine includes depositing multiple beads of fuel grain material adjacent to one another to form a fuel grain defining a combustion port extending axially therethrough, each bead of fuel grain material including a polymer based rocket fuel material. The depositing includes depositing beads of different form, beads of different composition, or both, such that the composition of the fuel grain varies within the fuel grain.

Embodiments can include one or any combination of two or more of the following features.

The method includes depositing beads of different form, beads of different composition, or both such that the composition of the fuel grain varies along a radius of the fuel grain.

The method includes depositing beads of different form, beads of different composition, or both such that the composition of the fuel grain varies along an axis of the fuel grain.

The method includes depositing beads of different form, beads of different composition, or both such that the composition of the fuel grain varies around a circumference of the fuel grain.

The method includes depositing beads of different form, beads of different composition, or both such that the composition of the fuel grain at a first location in the fuel grain differs from the composition of the fuel grain at a second location in the fuel grain.

At least some of the beads include a metallic or polymer additive material. In some cases, depositing beads of different composition includes depositing beads having a difference in one or more a weight percentage of the metallic or polymer additive material, a volume percentage of the metallic or polymer additive material, a shape of the metallic or polymer additive material, or a size of the metallic or polymer additive material. In some cases, depositing beads of different composition includes depositing beads having a difference in a composition of the metallic or polymer additive material.

Depositing beads of different composition includes depositing beads having a difference in a composition of the polymer based rocket fuel material. In some cases, depositing beads having a difference in a composition of the polymer based rocket fuel material includes depositing a first bead having a first polymer based rocket fuel material and depositing a second bead having a second polymer based rocket fuel material. In some cases, depositing beads having a difference in a composition of the polymer based rocket fuel material includes depositing beads composed of a blend of multiple polymer based rocket fuel materials, including depositing a first bead having a first blend of the multiple polymer based rocket fuel materials and depositing a second bead having a second nd of the multiple polymer based rocket fuel materials.

Depositing multiple beads of fuel grain material includes extruding the beads of fuel grain material from a nozzle of an additive manufacturing system.

Depositing beads of different composition includes: depositing beads of a first composition to form a first region of the fuel grain; and depositing beads of a second composition to form a second region of the fuel grain. In some cases, the first region is concentric with the second region. In some cases, the first region is adjacent to the second region along an axis of the fuel grain. In some cases, the method includes depositing the beads of the first composition using a first deposition head; and depositing the beads of the second composition using a second deposition device. In some cases, t method includes depositing the beads of the first composition and the beads of the second composition using a single deposition head. In some cases, at least some of the beads include a metallic or polymer additive material, and in which depositing beads of the first and second composition includes varying an amount of the metallic or polymer additive material provided to a nozzle of the single deposition head.

Depositing multiple beads of fuel grain material includes depositing multiple adjacent beads in a direction parallel to the axial length of the fuel grain to form a first layer of beads. In some cases, depositing multiple beads of fuel grain material includes forming a second layer of beads by depositing beads onto the first layer of beads, in which the first layer of beads forms an inner wall of the fuel grain, the inner wall defining the combustion port of the fuel grain. In some cases, depositing multiple beads of fuel grain material includes forming multiple additional layers, and in which the composition of the beads of one of the additional layers of beads differs from the composition of the beads of another one of the additional layers of beads.

The method includes varying an extrusion rate of the fuel grain material during the depositing.

The method includes stopping the depositing to define a void in the fuel grain. In some cases, the method includes disposing a second material into the void. In some cases, the second material includes one or more of a solid propellant or a high thermal conductivity material.

In a third aspect, combinable with the first and second aspects, a fuel grain for a hybrid rocket engine includes multiple, concentric layers of fuel grain material defining a combustion port extending through a body of the fuel grain, in which each layer includes multiple beads of fuel grain material, in which the multiple beads in a given layer are disposed adjacent to one another and bonded together, and in which adjacent concentric layers are bonded together, in which each bead of fuel grain material includes a polymer based rocket fuel material, and in which a composition of the fuel grain material varies along a radius of the fuel grain.

Embodiments can include one or any combination of two or more of the following features.

At least some of the beads include a metallic or polymer additive material. In some cases, the metallic or polymer additive material includes nanoscale or microscale metal or polymer particles. In some cases, the metallic or polymer additive material includes nanoscale aluminum particles. In some cases, the nanoscale aluminum particles are passivated with a polymer. In some cases, the nanoscale aluminum particles have an average diameter of between 5 nm and 20 nm. In some cases, one or more of a weight percentage of the metallic or polymer additive material or a volume percentage of the metallic or polymer additive material in the beads of the fuel grain material varies along the radius of the fuel grain. In some cases, the weight percentage or volume percentage of the metallic or polymer additive material in the beads of the fuel grain material varies monotonically from an inner wall to an outer wall of the fuel grain, the inner wall of the fuel grain defining the combustion port. In some cases, a size or shape of the metallic or polymer additive material in the beads of the fuel grain material varies along the radius of the fuel grain. In some cases, a composition of the metallic or polymer additive material in the beads of the fuel grain material varies along the radius of the fuel grain. In some cases, the fuel grain material includes between 75% and 95% by weight of the polymer based rocket fuel material and between 5% and 25% by weight of the metallic or polymer additive material.

A composition of the polymer based rocket fuel material varies along the radius of the fuel grain.

A density of the fuel grain material varies along the radius of the fuel grain.

The composition of the beads of the fuel grain material in a first region of the fuel grain differs from the composition of the beads of the fuel grain material in a second region of the fuel grain, and in which the first and second regions are adjacent to one another along the radius of the fuel grain. In some cases, the first and second regions each include multiple concentric layers of beads.

At least one of the concentric layers includes beads of multiple compositions. In some cases, at least some of the beads include a metallic or polymer additive material, and in which the beads an innermost one of the concentric layers have a greater weight percentage of the metallic or polymer additive material or greater volume percentage of the metallic or polymer additive material, as compared to the beads of an outermost one of the concentric layers. In some cases, at least some of the beads include a metallic or polymer additive material, and in which the metallic or polymer additive material in the beads of an innermost one of the concentric layers are smaller in size than the metallic or polymer additive material in the beads of an outermost one of the concentric layers.

The composition of a first bead of the fuel grain material differs from the composition of a second bead adjacent to the first bead.

The hybrid rocket fuel material includes an Acrylonitrile Butadiene Styrene (ABS) thermoplastic.

An inner wall of the fuel grain is textured, the inner wall defining the combustion port. In some cases, the fuel grain is configured such that when the inner wall of the fuel grain ablates due to combustion in the combustion port, a new textured surface of the fuel grain is exposed to the combustion port. In some cases, the inner wall of the fuel grain is composed of beads of the fuel grain material.

The fuel grain is fabricated in a freeform fabrication process.

The beads are fabricated in an extrusion process.

The fuel grain includes a thermally insulating material or a fiber encasing the fuel grain.

A void is defined in the body of the fuel grain. In some cases, a second material is disposed in the void. In some cases, the second material includes one or more of a solid propellant or a high thermal conductivity material.

In a fourth aspect, combinable with any of the previous aspects, a hybrid rocket engine includes a fuel grain including multiple, concentric layers of fuel grain material defining a combustion port extending through the fuel grain, in which each layer includes multiple beads of fuel grain material, in which the multiple beads in a given layer are disposed adjacent to one another and bonded together, and in which adjacent concentric layers are bonded together, in which each bead of fuel grain material includes a polymer based rocket fuel material and a metallic or polymer additive material, and in which a composition of the beads of the fuel grain material varies along a radius of the fuel grain; an oxidizer source configured to provide a flow of an oxidizer through the combustion port during operation of the hybrid rocket engine; a valve configured to control the flow of the oxidizer through the combustion port; a nozzle in fluid communication with the combustion port; and a casing, in which the fuel grain, the oxidizer source, and the valve are housed within the casing, and in which the nozzle extends beyond an end of the casing.

In a fifth aspect, combinable with any of the previous aspects, a fuel grain for a hybrid rocket engine includes multiple layers of fuel grain material defining a combustion port extending through a body of the fuel grain, in which each layer includes multiple beads of fuel grain material, in which the multiple beads in a given layer are disposed adjacent to one another and bonded together, and in which adjacent layers are bonded together, in which each bead of fuel grain material includes a polymer based rocket fuel material, and in which a composition of the beads of the fuel grain material, a form of the beads of fuel grain material, or both varies within the fuel grain.

Embodiments can include one or any combination of two or more of the following features.

The composition of the beads of the fuel grain material, a form of the beads of fuel grain material, or both varies along a radius of the fuel grain.

The composition of the beads of the fuel grain material, a form of the beads of fuel grain material, or both varies along an axis of the fuel grain.

The composition of the beads of the fuel grain material, a form of the beads of fuel grain material, or both varies around a circumference of the fuel grain.

The composition of the fuel grain at a first location in the fuel grain differs from the composition of the fuel grain at a second location in the fuel grain.

At least some of the beads include a metallic or polymer additive material. In some cases, one or more a weight percentage of the metallic or polymer additive material, a volume percentage of the metallic or polymer additive material, a shape of the metallic or polymer additive material, or a size of the metallic or polymer additive material varies within the fuel grain. In some cases, a composition of the metallic or polymer additive material varies within the fuel grain. In some cases, the metallic or polymer additive material includes nanoscale or microscale metal or polymer particles.

A composition of the polymer based rocket fuel varies within the fuel grain.

A density of the fuel grain material varies within the fuel grain.

A void is defined in the body of the fuel grain. In some cases, a second material is disposed in the void. In some cases, the second material includes one or more of a solid propellant or a high thermal conductivity material.

An inner wall of the fuel grain is textured, the inner wall defining the combustion port. In some cases, the fuel grain is configured such that when the inner wall of the fuel grain ablates due to combustion in the combustion port, a new textured surface of the fuel grain is exposed to the combustion port.

The details of one or more implementations are set forth in the accompanying drawings and the description below. Other features and advantages will be apparent from the description and drawings, and from the claims.

### BRIEF DESCRIPTION OF DRAWINGS

FIGS. 1 and 2 are perspective and cross-sectional diagrams, respectively, of a fuel grain for a hybrid rocket engine.

FIGS. 3A-3C are cross-sectional diagrams of a fuel grain.

FIGS. 4 and 5 are perspective and cross-sectional diagrams, respectively, of a fuel grain for a hybrid rocket engine.

FIG. 6 is a perspective diagram of a fuel grain for a hybrid rocket engine.

FIGS. 7A and 7B are cross-sectional diagrams of a fuel grain for a hybrid rocket engine.

FIG. 8 is a cross-sectional diagram of a fuel grain for a hybrid rocket engine.

FIG. 9 is a diagram of a fuel grain assembly.

FIG. 10 is a diagram of a hybrid rocket engine.

FIG. 11 is a cross-sectional diagram of a portion of a fuel grain.

FIGS. 12 and 13 are diagrams of additive manufacturing systems.

FIG. 14 is a flow chart.

### DETAILED DESCRIPTION

This document relates to fuel grains for hybrid rocket engines. The composition of the fuel grains described herein varies within the fuel grain, e.g., along a radius or axis of the fuel grain, circumferentially around the fuel grain, at specific locations within the fuel grain, or in another way. The fuel grains are formed by additive manufacturing techniques, enabling fabrication of fuel grains with a wide range of geometries of compositional variations. For instance, additively manufactured fuel grains having local compositional variations are formed of fused, concentric beads (referred to here as concentric beads) of fuel grain material stacked in fused layers to form an elongated, hollow structure.

The fuel grain material can include a polymer fuel material, alone or with an additive, such as a micron-scale or nanoscale additive, e.g., a metallic or polymer additive material. In some examples, the additive itself is a fuel material. For instance, the fuel grain material can be a compound of a polymer fuel material and micron-scale metallic material, or a polymer-nanoscale metallic material produced in a reactor at the molecular level. The type of the polymer fuel material, and the type, size, and amount of the additive material, affect the energetic release capability of the fuel grain material. Other compositional characteristics of the fuel grain material, such as the density of the material and the presence of local voids, can also affect the energetic release capability of the fuel grain.

By locally tailoring the energetic release capability of the fuel grain through local variations in the composition of the fuel grain material, the energetic release profile of the fuel grain can be tailored to achieve target performance objectives. In a specific example, nanoscale pure metallic material is used to elevate the energetic value of the fuel grain material. By altering the energetic value of the solid fuel by changing the composition of the fused concentric beads in the fuel grain from the initial port wall outward, thrust and specific impulse provided by the fuel grain over time can be adjusted. Together with adjustment to the oxidizer flow rate, a desired flight profile can be achieved.

In another example, macroscale discontinuities (e.g., voids) can impart sharply varying burn profiles over time. Moreover, non-printable materials can be added to the voids either during or after the printing process to achieve further performance tailoring. For instance, cast solid propellant can be positioned in printed voids to provide bursts of propulsion. High thermal conductivity materials can be positioned in printed voids to enhance grain pre-heating and regression rates.

In another example, the composition of a fuel grain can be tailored such that the fuel grain performance is optimized for various temperature ranges at which the fuel grain is expected to operate. For instance, such tailoring is relevant for tactical missiles launched from high altitude and low starting temperatures. For these missiles, much of the fuel grain has a high concentration of an additive elastomer that makes the fuel grain soft and less susceptible to thermal shock. However, at certain points in the flight envelope, e.g., at takeoff, a high thrust may be desired, and thus the additive elastomer is not present in the material that is to combust upon takeoff, thereby providing the fuel grain with the capability of high initial thrust and also stable functionality at low temperature.

In fuel grains having compositional variations, the composition or form of one or more of the fused concentric beads differs from the composition of the other fused concentric beads in the fuel grain, and affect the energetic release capability of the solid fuel grain as a whole. These compositional variations can include variations in the fuel grain material itself, including variations in the additive material and/or the polymer fuel material, e.g., variations in the weight or volume percentage of the additive material, the size or geometry (e.g., shape) of the particles of the additive material, the composition of the additive material, the composition of the polymer-nanoscale metallic material, the composition of the polymer fuel material (e.g., the type of ABS or other thermoplastic material, or the ratio of polymers in a blend of polymer formulations), or other suitable material variations. The compositional variations can include variations in the form of the fuel grain material, e.g., variations in the local density of the fuel grain material (e.g., instantiated by introducing localized microscale porosity into certain beads or areas), the size or geometry (e.g., width or shape) of the beads of fuel grain material, the presence of local mesoscale voids in the fuel grain (e.g., instantiated by locally varying the amount of material extruded), the presence of macroscale discontinuities in the fuel grain, or other suitable form variations.

In some examples, a compositional variation in the fuel grain is a sharp transition between one composition and another. In some examples, a compositional variation in the fuel grain is a gradient variation in which the composition varies gradually (e.g., in a stepwise fashion) from a first composition in a first area of the fuel grain to a second composition in a second area of the fuel grain. In a specific example of a gradient variation in additive weight percentage, a first area of the fuel grain includes 5 wt % of nanoscale metallic particles and a second area of the fuel grain includes 25 wt % of the same type of nanoscale metallic particles, and in a transition region between the first area and the second area, the weight percentage of the nanoscale metallic particles is gradually increased.

The fuel grains described herein can be fabricated by additive manufacturing techniques, such as by extrusion and deposition of concentric beads of the fuel grain material. In some examples, compositional variation can be achieved by controlling the composition of the material provided by a single injector in advance of the deposition head of an additive manufacturing system. For instance, to fabricate a fuel grain having local variations in the weight percentage of a nanoscale metallic additive material, an amount of the nanoscale metallic material or nanoscale metallic material blended with a liquid medium is varied upstream of the single injector of the additive manufacturing system. In some examples, compositional variation is achieved by depositing fuel grain materials of different compositions from multiple, distinct deposition heads and nozzles of an additive manufacturing system.

Form variations can be achieved by the extrusion and deposition process, e.g., by changing an amount of extruded material or by changing components of the extruder itself. For instance, certain extruders may introduce microscale porosity into the extruded material, while other extruders extrude substantially non-porous materials; the extruder can be changed during the additive manufacturing process to achieve local variations in microscale porosity and hence local variations in density of the fuel grain material. Other changes to the extruders, such as use of extruders having nozzles of various geometries (e.g., circular or non-circular such as square, rectangular, star, ellipsoidal, or other shapes) or extruders having nozzles with variable diameter, can also be implemented to create local form variations. When a deposition system having multiple nozzles is used, the nozzles can have the same geometry or different geometries. The speed of extrusion can be varied to obtain beads of different sizes (e.g., widths). Extrusion can be stopped and restarted at specific locations to obtain local macroscale voids.

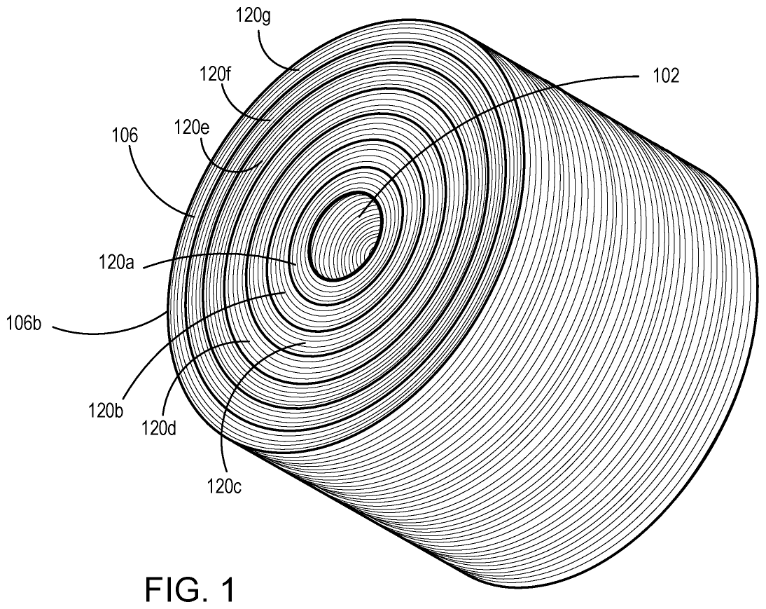

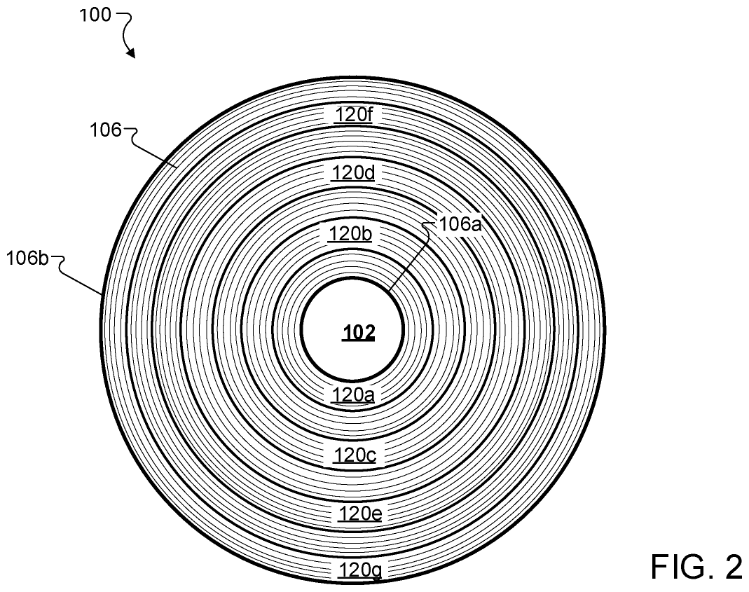

FIGS. 1 and 2 show a perspective view and a cross-sectional view, respectively, of an example cylindrical fuel grain 100 for a hybrid rocket engine. In the cross-sectional view of FIG. 2, the axis of the fuel grain 100 is oriented into the page of the figure. The fuel grain 100 has a generally cylindrical shape, e.g., an elongated tubular shape with a substantially circular cross section. A combustion port 102 extends axially through the center of the fuel grain 100. The combustion port 102 has a substantially circular cross section. In the example of FIGS. 1 and 2, the cylindrical fuel grain 100 has a composition that varies along the radius of the fuel grain 100; however, other geometries of composition variations are also possible, as discussed below. Moreover, although the fuel grain 100 is cylindrical and with a substantially cylindrical combustion port, other shapes of fuel grains and combustion ports can also have local compositional variations. For instance, other elongated fuel grains can have local compositional variations, as can other shapes of fuel grains, such as disc-shaped fuel grains. Additionally, fuel grains with local compositional variations can have various shapes of combustion ports, and can have one or multiple combustion ports.

The example cylindrical fuel grain 100 is formed from concentric beads 104 of fuel grain material that are bonded (e.g., fused) to one another to form a solid structure. Each concentric bead 104 has a generally ring-shaped, circular structure, with a substantially circular length of material and a substantially circular opening defined within the circular length of material. The radius of a concentric bead of a cylindrical fuel grain is the radius of the cylinder at the position of that bead. A given bead 104 is fused at its outer edge (e.g., in the direction of the radius of the fuel grain 100) to a concentric bead of a larger radius and at its inner edge to a concentric bead of a smaller radius.

Each concentric bead 104 is also fused along the axis of the fuel grain 100 to other concentric beads of substantially the same radius. Concentric beads that are fused along the axial direction are not concentric with one another, but are concentric with other concentric beads in the radial direction. The multiple concentric beads of substantially the same radius that are fused together along the axial direction of the fuel grain 100 constitute a layer 106 of the fuel grain. The concentric beads 104 are thus arranged into concentric, substantially cylindrical layers 106 with substantially circular cross section. An innermost layer 106a forms an initial combustion chamber port wall of the fuel grain 100 and an outermost layer 106b forms an outer wall of the fuel grain. The innermost layer 106a defines the initial wall of the combustion port 102. The layers 106 of concentric beads are formed by a freeform fabrication process, e.g., an additive manufacturing process such as extrusion and deposition, as discussed in more detail below. In the example of FIGS. 1 and 2, the composition of the layers 106 varies radially from the innermost layer 106a to the outermost layer 106b of the fuel grain 100, as discussed below. In some examples, the fuel grain 100 can have local compositional variations in other geometries, e.g., axial or circumferential variations, variations on a Cartesian coordinate grid, or variations in particular positions within the fuel grain.

Each concentric bead of fuel grain material includes a polymer based rocket fuel material, e.g., such as acrylonitrile butadiene styrene (ABS) thermoplastic or another polymer based rocket fuel material having desired combustion properties. Each concentric bead of fuel grain material can also include micron-scale or nanoscale additives, such as micron-scale or nanoscale metal particles (e.g., aluminum or magnesium particles), micron-scale or nanoscale polymer particles, or other suitable additives. In some examples, the micron-scale or nanoscale metallic particles are passivated with a polymer coating. In some examples, the micron-scale or nanoscale metallic particles have an oxide shell (e.g., aluminum particles can have an aluminum oxide shell). The additive particles can be of any suitable geometry, e.g., spheres, flakes, ellipses, or other geometries.

When the fuel grain material includes micron-scale additives (e.g., micron-scale metallic or polymer particles), the micron-scale particles have an average dimension (e.g., diameter) of between 1 μm and 1000 μm, e.g., between 1 μm and 500 μm or between 1 μm and 100 μm, e.g., 1 μm, 10 μm, 25 μm, 50 μm, 100 μm, 250 μm, 500 μm, or 1000 μm. When the fuel grain material includes nanoscale additives (e.g., nanoscale metallic or polymer particles), the nanoscale particles have an average dimension (e.g., diameter) of less than 1 μm, e.g., 500 nm or less, or 100 nm or less, e.g., 500 nm, 400 nm, 300 nm, 200 nm, 100 nm, 50 nm, 20 nm, 10 nm or another diameter. Generally, the fuel grain material is composed of between about 75% and 95% by weight of the hybrid rocket fuel material and between about 5% and 25% by weight of the micron-scale or nanoscale additive. In some examples, higher concentrations of additives can be present in the fuel grain material.

In some cases, the presence of nanoscale additives in the fuel grain material increases the burn rate of the fuel grain as compared to fuel grain material with micron-scale additives, or as compared to fuel grain material without additives. For instance, a fuel grain composed of ABS with 5% by weight concentration of nanoscale (e.g., 20 nm diameter) aluminum particles can have a faster burn rate than that of a fuel grain composed of ABS with an equivalent (or higher) weight concentration of micron-scale (e.g., 44-micron) aluminum particles. By tailoring the amount of additive in the fuel grain material at specific locations in the fuel grain, the energetic release profile of the fuel grain can be tailored to suit specifications, e.g., imposed by a target flight profile. Similarly, the density (e.g., porosity) of the fuel grain material impacts the burn rate; by tailoring the local density of the fuel grain material, the burn rate of the fuel grain can be tailored to correspond to specific points in a target flight envelope.

When incorporated into a hybrid rocket engine, an oxidizer is introduced into the combustion port 102 of the fuel grain 100. Combustion occurs along the exposed surface area of the innermost layer 106a of concentric beads, e.g., the concentric beads in the layer 106a forming the initial combustion port wall undergo a phase change from solid to gas or from solid to entrained liquid droplet to gas depending on the type of polymer fuel used. As the phase change occurs, the next concentric layer of beads is exposed to the combustion port 102, and the concentric beads of that newly exposed layer undergo a phase change. This process continues and persists during the operation of the hybrid rocket engine until either oxidizer flow is terminated or the solid fuel is exhausted (e.g., until the concentric beads of the outermost layer 106b are exposed to the combustion port 102).

The oxidizer flow into the combustion port 102 of the fuel grain 100 and the composition of the layers of concentric beads in the fuel grain can be tailored to achieve a target flight profile. For example, a rocket powered vehicle may demand high thrust upon launch but transition to less thrust but higher specific impulse during flight. The oxidizer flow and the composition of the fuel grain can be tailored to achieve this flight profile. For instance, oxidizer flow can be at its highest setting upon launch and the innermost fused layer of concentric beads of solid fuel forming a first region of the fuel grain can be composed of a polymer fuel material with a high concentration of nanoscale metallic material such as pure aluminum. A nanoscale pure metal such as aluminum is highly energetic compared to polymer fuels without metallic particles or polymer fuels containing micron-scale metallic particles. The thrust output of a hybrid rocket engine is modulated by the energy output of the solid fuel of the fuel grain when blended with gaseous oxidizer flow within the combustion port of the fuel grain. The higher the energetic value of the solid fuel that undergoes a phase change from solid to gas when combusted with oxidizer gas, the faster the regression rate or consumption rate of the solid fuel of the fuel grain, and thus the higher the thrust output that is provided to the rocket powered vehicle. Specific impulse is a measurement of propellant economy. Specific impulse is amplified when using high energetic release fuels given that these fuels elevate both combustion temperature and pressure. In this way reaction mass generated can be increased to produce higher thrust using less propellant. Thus, with an adjustment in oxidizer flow to a lower setting following launch, the propellants will combust more slowly, but with higher pressure and temperature given the presence of the right blend of polymer and nanoscale aluminum in the fuel grain. This enables the rocket powered vehicle to accelerate more slowly but enabling improved fuel economy during flight.

The innermost layer 106a forming the initial combustion port wall has a ribbed texture that is formed by the adjacent, generally circular beads that constitute the layer 106a. The beaded, ribbed texture of the layer 106a presents a large surface area of fuel grain material to the combustion port, e.g., a surface area that is greater than the surface area of a similarly sized but untextured (e.g., smooth) surface. Subsequent concentric layers 106 also have a beaded, ribbed texture, such that a large surface area of fuel grain material is continually presented to the combustion port. When the innermost layer 106a of concentric beads pyrolyzes, ablates, and phase changes due to gas combustion in the combustion port 102, a new ribbed, curved surface of the fuel grain (e.g., the next layer of concentric beads) is exposed to the combustion port 102. The large surface area of each exposed layer contributes to efficient operation of a hybrid rocket engine that includes the fuel grain. In some examples (discussed below), the layers can have a texture that also induces an eddy current which contributes to efficient combustion by causing the flow of fuel gas further away from the combustion port wall enabling more efficient mixing with the oxidizer gas flowing through the combustion chamber port.

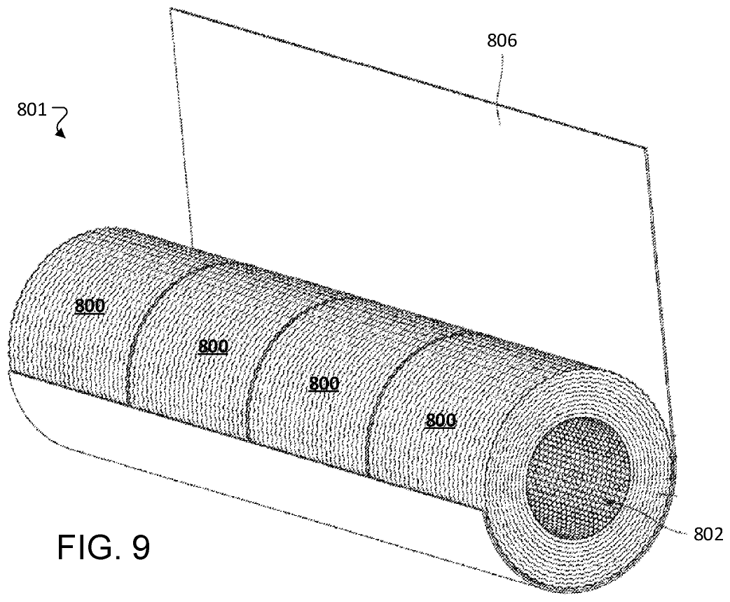

The fuel grain 100 has an outer cover 130 disposed over the outermost layer 106b of the fuel grain 100. The outer cover 130 can be a structural reinforcing fiber, e.g., carbon fiber filament or carbon fiber tape that is wound around the fuel grain 100 at alternating angles to provide structural reinforcement to the fuel grain 100. In some examples, a thermally protective cover (not shown) is disposed between the outer cover 130 and the outermost layer 106b of the fuel grain. The thermally protective cover, which can be in the form of a cloth, paper, or reinforcing tape, helps prevent burn through when the engine is operated such that the combustion heat generated in the fuel grain 100 is high enough to otherwise melt or burn the outer cover. The wrapped fuel grain 100 is placed into an engine case of a rocket (see FIG. 9).

In the example of FIGS. 1 and 2, the composition of the concentric beads varies radially between the concentric beads of the innermost layer 106a and the concentric beads of the outermost layer 106b of the fuel grain 100, e.g., such that the composition of the concentric beads in each layer is substantially constant but the composition of the concentric beads in one of the layers differs from the composition of the beads in at least one other concentric layer. For instance, one or more of the amount (e.g., weight percentage or volume percentage), size (e.g., average dimension (diameter)), geometry, or composition of the micron-scale or nanoscale additive material in the fuel grain material varies along the radius of the fuel grain. Other radial variations are also possible, such as variations in the composition of the polymer fuel material or variations in the form of the fuel grain.

Specifically, in the example of FIGS. 1 and 2, there are seven concentric regions 120a-120g, each region of different composition than at least one of the other regions. Each region 120a-120g includes one or more concentric layers of concentric beads. At the interface between two concentric regions, beads that are adjacent to one another in the radial direction have a different composition. In the example of FIGS. 1 and 2, each region 120a-120g includes six concentric layers 106 of concentric beads. In some examples, the number of concentric layers included in each region can differ among some or all of the regions. In some examples, one or more of the concentric regions each includes only a single concentric layer of fuel material, e.g., such that there is an individual concentric layer that has a composition that differs from both radially adjacent concentric layers.

This radial gradient in composition enables the composition of the fuel grain to be tailored to provide customized performance characteristics. For instance, a fuel grain can be designed to meet the needs of a target flight envelope for the hybrid rocket engine in which the fuel grain is to be deployed. For instance, at startup of the hybrid rocket engine, a hot burn with a fast burn rate may be desirable, while a slower burn may be better suited to a cruise portion of the flight. To meet the demands of this flight profile, the inner few concentric layers of the fuel grain, which are exposed to the combustion port early in the flight (e.g., at startup), can be formed of beads composed of a high weight percentage of nanoscale metallic material or of nanoscale metallic material with a small diameter. This composition produces a hot and fast burn rate producing high thrust. The outer concentric layers of the fuel grain, which are exposed to the combustion port later in the flight (e.g., during cruising), can be formed of concentric layers composed of a lower weight percentage of nanoscale metallic material or of nanoscale metallic material with a larger diameter. This composition produces a burn that is less hot and slower burning than that of the inner concentric layers of the fuel grain.

In some examples, a fuel grain with a radial gradient in composition can be used in conjunction with systems that enable termination of an engine's operation and thrust on command, followed by restarting the engine operation. Termination of the engine's operation can be achieved by ceasing oxidizer flow into the combustion port; the engine can then be restarted by resuming oxidizer flow upon re-ignition. With a fuel grain with a radial compositional gradient, the composition of the fuel grain can be tuned such that, at the point in the operation at which engine restart is to occur, a specific composition (e.g., a specific combination of nanoscale metallic material, micron-scale metallic material, or both, mixed with the polymer fuel material) to create a desired thrust and impulse performance.

For instance, a missile may be designed using throttling of oxidizer flow and the gradient composition of the fuel grain to first transition from high thrust to cruise performance, followed by termination of engine operation. If restarted later, the highest achievable thrust may be desirable. For example, in a boost glide type missile, it may be desirable for the engine to boost thrust to a given speed and altitude, followed by a cruise phase to attain a desired range, then followed by engine operation shut-down. Once the engine is shut down, the missile operates in a glide phase, e.g., using fold-out or deployable wing structures, e.g., to surveil a target area. At some point during the glide phase, an operator may instruct the missile to reform itself into missile configuration and restart the rocket engine, thereby accelerating the missile onto the target at high speed.

In another example, an engine including a gradient composition fuel grain powers a second or third stage of a launch vehicle. After firing to attain initial orbit, oxidizer flow is ceased to terminate thrust. However, the engine may need to be restarted to place the payload into a different orbit. In so doing, an operator wants the engine to perform at the highest possible specific impulse to achieve a desired delta V. As in the previous example, oxidizer shut-off will stop the engine. The engine may then be restarted, e.g., to handle rendezvous with a space station or satellite in orbit, which can demand very low amounts of thrust for short burn times. This type of operation can be achieved by oxidizer throttle control and re-ignition, and/or by the remaining solid fuel having a composition such that its combustion characteristics accommodate low thrust, at high specific impulse.

In some examples, the same compositional characteristic (e.g., the composition of the fuel grain material (such as weight or volume percentage of the additive, size or geometry of the additive, composition of the additive, composition of the polymer fuel material, or other compositional characteristics) or the form of the fuel grain material (e.g., density, size or shape of the beads, presence of mesoscale voids or macroscale discontinuities) is varied across all of the regions of the fuel grain. For instance, the concentric beads of the first region 120a can have a first weight percentage of a nanoscale metallic material, the concentric beads of the second region 120b can have a second, different weight percentage of the nanoscale metallic material, and the concentric beads of the third region 120c can have a third, different weight percentage of the nanoscale metallic material. In some examples, different compositional characteristics are varied for some or all of the regions of the fuel grain. For instance, the concentric beads of the first region 120a can have a first weight percentage of a first type of nanoscale metallic material, the concentric beads of the second region 120b can have a second, different weight percentage of the same type of nanoscale metallic material, and the concentric beads of the third region 120c can have a different weight percentage of a micron-scale metallic material. Additionally, during deposition, the concentric bead dimensions can be adjusted such that from one concentric bead to the next, the tow (width) or thickness of the bead can be adjusted as well as the density by decreasing or increasing the bond area of each concentric bead in relation to the next concentric bead. By changing density or bead dimensions, the regression rate can also be adjusted to correspond to a specific flight profile attribute. While the discussion of FIGS. 1 and 2 refers specifically to such compositional variations having a radial geometry, other geometries can also be implemented, e.g., variation in an axial direction from a first end 122 to a second end 124 of the fuel grain 100, variation around the circumference of the fuel grain 100, specific location variations, or other geometries of compositional variations.

In some examples of radial compositional variations, the compositional characteristic varies monotonically from the beads of the innermost concentric layer 106a or region 120a to the beads of the outermost concentric layer 106b or region 120b of the fuel grain. For instance, the weight percentage, volume percentage, or size of micron-scale or nanoscale metallic material in the beads can decrease from the first region 120a to the second region 120b and then to the third region 120c. In some examples, the variation is not monotonic. For instance, the weight percentage, volume percentage, or size of micron-scale or nanoscale metallic material in the concentric beads can increase from the first region 120a to the second region 120b but then decrease to the third region 120c.

In a specific example, the weight percentage of the additive (e.g., a micron-scale or nanoscale metallic or polymer material) is highest in the concentric beads of one or more of the inner concentric layers or regions to provide a hot and fast burn rate, e.g., suitable for a startup phase of the flight. For instance, the concentric beads of the inner region (e.g., the concentric beads of the first region 120a) can have a composition of between about 75% and 85% by weight of polymer based rocket solid fuel material and between about 15% and 25% by weight of micron-scale or nanoscale metallic material. The composition can increase monotonically toward the beads in the outermost concentric layer 106b, with the beads in each successive concentric layer or region having a higher weight percentage of polymer based rocket fuel material than the beads in the preceding layer or region. For instance, the concentric beads of the outer region (e.g., the concentric beads of the second region 120b and the third region 120c) can have a composition of between about 85% and 95% by weight of polymer based rocket fuel material and between about 5% and 15% by weight of micron-scale or nanoscale metallic material. It is also possible to blend the use of micron-scale and nanoscale metallic material in the beads of hybrid rocket fuel material or adjust the content of both metallic materials from one region of fuel to the next.

In a specific example, the concentric beads of the inner region include micron-scale or nanoscale metallic material that is smaller than the micron-scale or nanoscale metallic material in the beads of the other regions. Smaller particles of metallic material have more surface area, and thus contribute to a hotter, faster burn, than larger particles of metallic material of the same composition. For instance, the concentric beads of the inner region (e.g., the first region 120a) can contain aluminum nanoparticles with a diameter of between 5 nm and 15 nm, and the concentric beads of the second region 120b can contain aluminum nanoparticles with a diameter of between 15 nm and 20 nm, and the concentric beads of the third region 120c can contain micron-scale aluminum particles with a diameter of about 2 μm.

Variation on a per-region basis enables gradual changes in composition to be achieved, which can contribute to smooth operation of the hybrid rocket engine, e.g., by avoiding sudden, sharp changes in the combustion performance of the fuel grain 100. For instance, the fuel grain can be designed to implement a smooth transition between a hot, fast burn and a subsequent cooler, slower burn.

In some examples, to achieve a gradual variation in composition, each region is formed of concentric beads (and thus one or more concentric layers) of uniform composition, and each successive region in a set of transitional regions has a slight variation in composition relative to the preceding region. For instance, the weight percentage of micron-scale or nanoscale metallic material in the concentric beads of a set of ten transitional concentric layers, collectively a transitional region, can be 25% for the beads of an innermost region, decreasing by 1 weight percent for each successive region over ten concentric layers to reach 15% for the beads of a tenth region.

In some examples, to achieve a gradual variation in composition, some or all of the concentric layers of beads are formed of concentric beads of two different compositions, with the ratio between the two types of concentric beads changing gradually over a transitional region. For instance, a region including ten transitional concentric layers can be positioned concentrically between an inner adjacent region with concentric beads including 25% by weight of a particular nanoscale metallic material and an outer adjacent region with concentric beads including 10% by weight of that same nanoscale metallic material. In an innermost region of the set of transitional concentric layers, the concentric beads include 25% by weight of nanoscale metallic material. Each successive concentric layer in the set of a transitional region is formed of a combination of a first composition of concentric beads that include 25% by weight of nanoscale metallic material and a second composition of concentric beads that include 10% by weight of nanoscale metallic material, with the ratio between the first composition of concentric beads and the second composition of concentric beads decreasing. For example, a second layer of the set of ten concentric layers can include a 9:1 ratio of concentric beads of the first composition to concentric beads of the second composition, while an eighth region of the set of ten concentric layers includes a 2:8 ratio of concentric beads of the first composition to concentric beads of the second composition. A final concentric layer of the transitional region is formed only of concentric beads that include 10% by weight of nanoscale metallic material.

The compositional variation can be a complex variation that is tuned to match an anticipated flight profile for the hybrid rocket engine in which the fuel grain 100 is to be used. For instance, the concentric regions of a fuel grain can have compositional variations to accommodate a planned flight profile that includes a startup phase with high power needs, followed by a cruising phase, then a high-power thrust phase to change altitude, followed by another cruising phase.

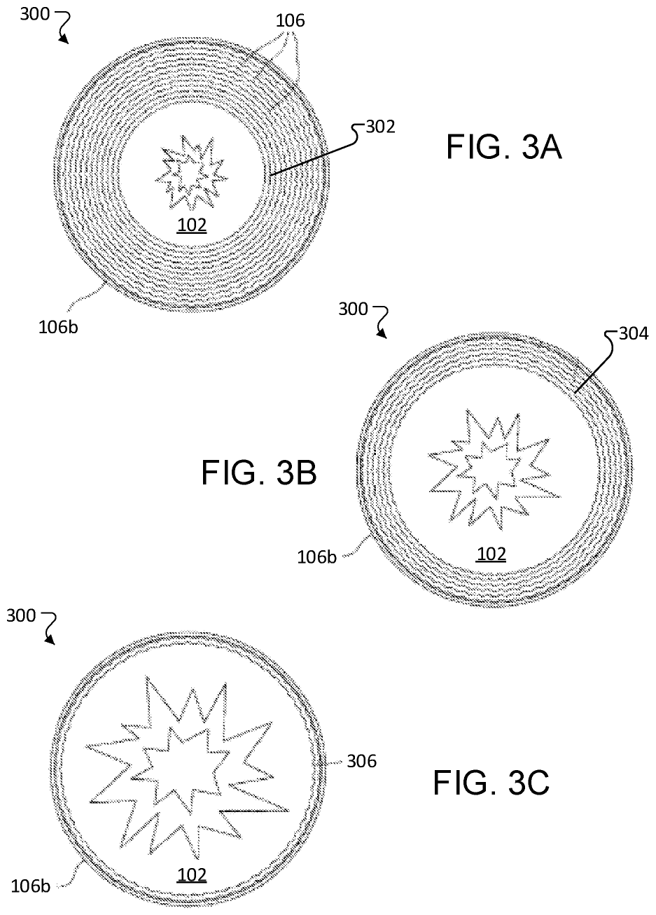

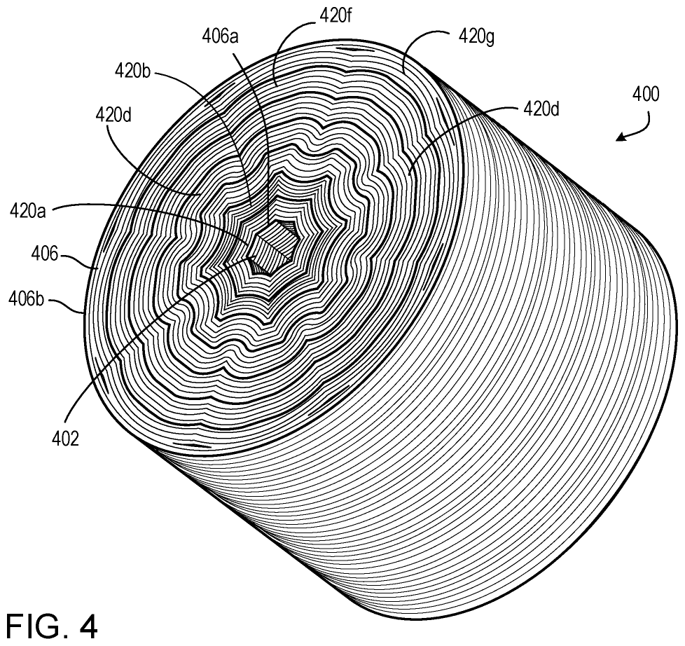

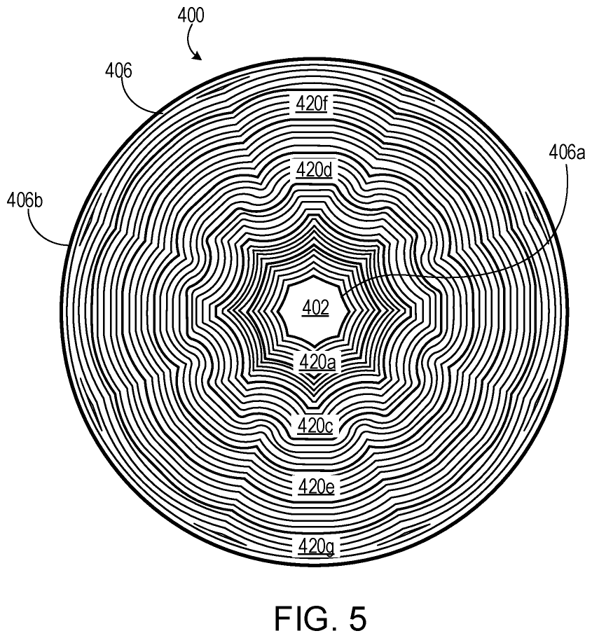

FIGS. 3A-3C shows a cross sectional view of the fuel grain 100 at different phases of the flight envelope. As discussed above, when an oxidizer is introduced into the combustion port 102 of the fuel grain 100, combustion occurs along the exposed surface of the innermost layer 106a of concentric beads. As the concentric beads of that innermost layer undergo a phase change, the next layer of concentric beads is exposed to the combustion port 102. Each successive layer 106 of concentric beads is exposed to the combustion port 102 until the outermost layer of concentric beads 106b is reached and the fuel grain is depleted. The fuel grain is configured such that the wall of the combustion port 102 appears ribbed. When the wall of the combustion port (e.g., initially the innermost layer 106a of concentric beads) pyrolyzes, ablates, and phase changes due to gas combustion in the combustion port 102, a new ribbed, curved surface of the fuel grain (e.g., the next layer of concentric beads) is exposed to the combustion port 102.

In the specific example of FIGS. 3A-3C, a fuel grain 300 includes a first region 300 including a first set of concentric layers formed of concentric beads composed of 25% by weight of 10 nm diameter nanoscale metallic material. The first set of layers of concentric beads in the first region 302 are exposed to the oxidizer in the combustion port 102 at startup and provide a hot, fast burn for the hybrid rocket engine.

Referring specifically to FIG. 3B, after the concentric beads in the first region 302 are exhausted, a second set of concentric layers of concentric beads in a transition region 304 are exposed to the combustion port. The second set of concentric layers acts as a compositional transition between the first set of concentric layers and a third set of concentric layers in a third region 306. The third set of concentric layers in the third region 306 are composed of concentric beads including 10% by weight of 20 nm diameter nanoscale metallic material. The second set of concentric layers in the transition region 304 are composed of both concentric beads including 25% by weight of 10 nm diameter nanoscale metallic material and concentric beads including 10% by weight of 20 nm diameter nanoscale metallic material, with the ratio of the former to the latter gradually decreasing with each successive set of concentric layers in the transition region 304. As the concentric beads of each successive set of concentric layers in the transition region 304 is exposed to the combustion port 102, the temperature and burn rate in the hybrid rocket engine gradually decrease due to the gradual change in composition across the concentric beads in the transition region 304.

Referring to FIG. 3C, after the second set of concentric layers in the transition region 304 is exhausted, the third set of concentric layers of the third region 306 is exposed to the combustion port. These concentric layers, with less and smaller nanoscale metallic material than the previous set of layers, provide a slower, cooler burn that is suitable for a cruising phase of the flight envelope. When the third set of concentric layers forming a region is exhausted, the fuel grain 100 is depleted.

Geometric variations in composition can be implemented in fuel grains of other configurations. For instance, FIGS. 4 and 5 show a perspective and a cross-sectional view, respectively, of a fuel grain 400 for a hybrid rocket engine. Overall, the fuel grain 400 has a generally cylindrical shape with a substantially circular cross section. A combustion port 402 extends axially through the center of the fuel grain 400. The combustion port 402 has a roughly octagonal cross-sectional shape. Other cross-sectional shapes are also possible, e.g., other polygons or irregular shapes. Other shapes of fuel grains other than cylindrical fuel grains are also possible. The discussion of the fuel grain 400 refers to radial compositional variations, but other geometries of compositional variations are also possible, e.g., axial or circumferential variations, variations on a Cartesian coordinate grid, or variations in particular positions within the fuel grain.

The fuel grain 400 is formed from fused, stacked layers of concentric beads of fuel grain material that are bonded (e.g., fused) to one another to form a solid structure, as described above for FIGS. 1 and 2. The layers of concentric beads are arranged into concentric regions 406. In the example of FIGS. 4 and 5, the regions 406 have closed, non-polygon cross-sections, the shapes of which are dictated by the cross-sectional shape of the combustion port 402. The fuel grain is wrapped in an outer cover (not shown), e.g., carbon fiber filament or carbon fiber tape, to provide structural reinforcement to the fuel grain 400. In some examples, the fuel grain is also wrapped in a thermally protective cover. In other examples, the fuel grain is wrapped into a protective cover that thermally protects and structurally reinforces the fuel grain and prevents burn through. The protective wrapping may also be in the form of a shaped tube, the inner diameter of which tightly fits against the fuel grain that inserted within it. The wrapped fuel grain 400 is placed into an engine case of a rocket (see FIG. 9). In some instances, the protective wrap or tube serves also as the engine case.

The cross-sectional shape of the combustion port 402, and the cross-sectional shapes of the concentric beads forming each region 406, induces a vortex flow (e.g., a swirling current) of oxidizer through the combustion port 102 during operation of the hybrid rocket engine. Vortex flow can enhance efficiency of operation of the fuel grain 100, e.g., by both increasing combustion residence time and by increasing the contact between oxidizer and fuel grain material. Other cross-sectional shapes or textures can also be used to encourage vortex flow in the combustion port 402.

The composition of the concentric beads of fuel grain material in the fuel grain 400 varies within the fuel grain. For instance, the fuel grain can have a radial variation in composition, e.g., as described above for FIGS. 1 and 2. Specifically, each concentric bead of fuel grain material includes a polymer based rocket fuel material, e.g., ABS thermoplastic, and an additive, such as a micron-scale or nanoscale metallic or polymer material. The composition of the concentric beads varies radially in the fuel grain, e.g., as described above. In the example of FIGS. 4 and 5, there are seven concentric beaded regions 420a-420g, each region including concentric beads of different composition than at least one of the other regions. As described above, this radial gradient in composition enables the composition of the fuel grain to be tailored to provide customized performance characteristics. Other variations can also be implemented, e.g., axial variations, circumferential variations, variations on a Cartesian coordinate grid, or localized variations in particular positions within the fuel grain.

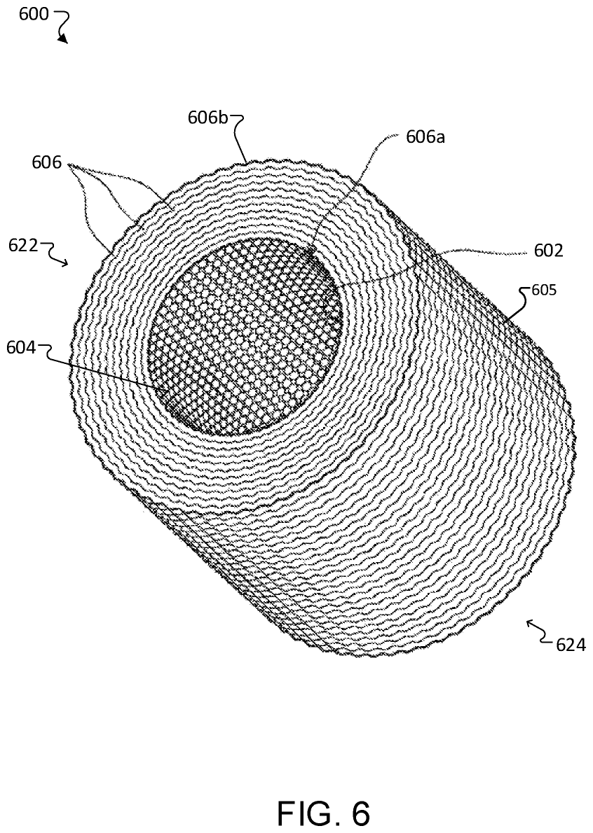

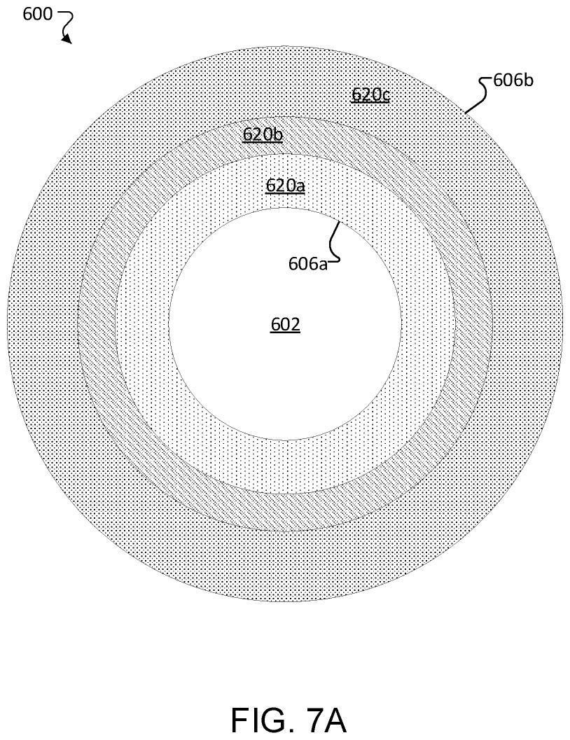

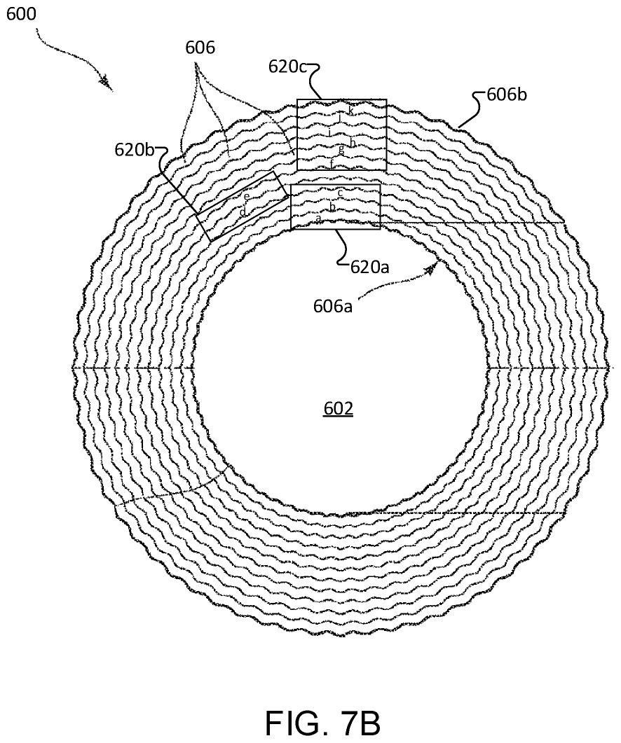

FIGS. 6 and 7A-7B shows a perspective view and cross-sectional views, respectively, of a fuel grain 600 for a hybrid rocket engine. FIG. 7A shows a simplified cross-sectional view of the fuel grain 600, and FIG. 7B shows detail of the concentric beads. The fuel grain 600 has a generally cylindrical shape with a substantially circular cross section. A combustion port 602 extends axially through the center of the fuel grain 600.

The fuel grain 600 is formed from blisters 604 of fuel grain material that are bonded (e.g., fused) to one another to form concentric beads 605, with adjacent concentric beads fused to one another to form a solid structure, as described above. As described above, each concentric bead of fuel grain material includes a polymer based rocket fuel material, e.g., ABS thermoplastic, and a micron-scale or nanoscale metallic material. The concentric beads 605 are arranged into concentric layers 606 of beads collectively forming a region when composed of the same composition. The arrangement of the concentric beads 605 of fuel grain material gives rise to texturing along the wall of the combustion port 602. In the example of FIGS. 6 and 7A-7B, the texturing is characterized by a series of projections and depressions that extend axially along at least a portion of the length of the fuel grain. In some examples, the texture can be characterized by ribs, dimples, undulations, or other textural features that increase the surface area relative to a smooth surface, e.g., as described in U.S. Pat. No. 10,286,599, the contents of which are incorporated here by reference in their entirety.

The example fuel grain 600 has a radial variation in composition from an innermost layer 606a of concentric beads to an outermost layer 606b of concentric beads of the fuel grain 100. In the example of FIGS. 7A-7B, there are three radially adjacent regions of different composition: a first, inner region 620a, a second region 620b adjacent to the first region 620a, and a third, outer region 620c adjacent to the second region 620b.

A box is drawn around a portion of each region 620a-620c in FIG. 7B for illustration purposes. The first region 620a includes three adjacent fused layers of concentric beads a, b, c; the second region 620b includes two adjacent fused layers of concentric beads d, e; and the third region 620c includes six adjacent fused layers of concentric beads f, g, h, i, j, k. At the interface between two regions, adjacent beads in the two regions have different composition. In some examples, the fuel grain 600 can have local compositional variations in other geometries, e.g., axial or circumferential variations, variations on a Cartesian coordinate grid, or variations in particular positions within the fuel grain.

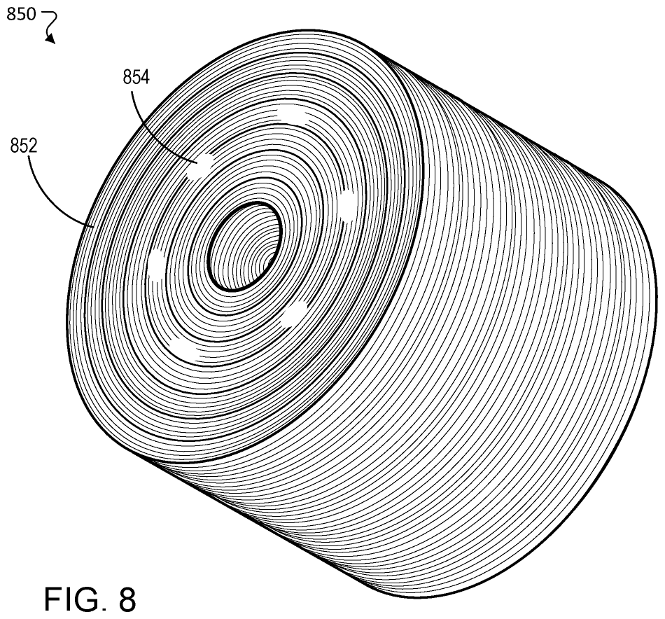

Referring to FIG. 8, an example cylindrical fuel grain 850 is formed of concentric beads 852 of substantially uniform composition. The fuel grain 850 includes local macroscale voids 854 at specific positions in the fuel grain. These voids 854 have dimensions that are defined during the additive manufacturing process, e.g., by stopping the extrusion of the fuel grain material at certain points in the process. In the illustrated example, the voids 854 are positioned at regular intervals around the circumference of the fuel grain 850 and are all at substantially the same radial location. In some examples, the voids 854 can be positioned at irregular positions circumferentially and/or radially. The voids can be arranged at regular or irregular intervals along the axis of the fuel grain 850. In the illustrated example, the voids 854 are empty. In some examples, the voids 854 are void of the surrounding fuel grain material but include another material, such as a different fuel grain material. In some examples, a separately manufactured device is disposed in one or more of the voids 854, e.g., using pick-and-place technology.

Referring to FIG. 9, in some examples, individual fuel grain sections 800 are assembled into a fuel grain assembly 801, e.g., by fusion bonding. The individual fuel grain sections 800 can be any of the fuel grains described above. An assembly 801 of multiple fuel grain sections 800 is useful, e.g., to provide a fuel grain assembly capable of producing more thrust than is possible from an individual fuel grain fabricated on the same additive manufacturing platform. In some examples, a fuel grain assembly 801 can be manufactured to meet a thrust demand of over 100,000 pounds of force (lbf).

An end of each of the individual fuel grain sections 800 is bonded to an end of an adjacent fuel grain. The resulting fuel grain assembly 801 is an elongated, cylindrical structure with a combustion port 802 extending axially through the entire length of the fuel grain assembly. In some examples, each of the fuel grain sections 800 in the fuel grain assembly 801 has the same compositional variation, e.g., the same radial gradient in composition, such that the fuel grain assembly 801 as a whole possesses a uniform radial gradient. In some examples, one or more of the fuel grain sections 800 in the fuel grain assembly 801 has a different compositional variation than the other fuel grains, e.g., a different radial gradient in composition or a uniform composition throughout, such that the composition of the fuel grain assembly 400 varies both radially and axially.

In some examples, a connector (not shown) extends from the end of one fuel grain and mates with a cavity at the end of an adjacent fuel grain to secure the fuel grains together in the fuel grain assembly 801. In some examples, polymer based rocket fuel material (e.g., ABS) is heated to above its glass transition temperature but below the ignition temperature of the micron-scale or nanoscale metallic material and applied (e.g., by spraying or spreading) to the ends of adjacent fuel grains. Upon cooling, the material creates a strong bond between the fuel grain sections to secure the fuel grains together in the fuel grain assembly 801.

The fuel grain assembly 801 is encased in an outer cover 806, e.g., carbon fiber filament or carbon fiber tape, to provide structural reinforcement to the fuel grain assembly 801 400. In some examples, the fuel grain assembly 801 is also wrapped in a thermally protective cover. In other examples, the wrapping provides both thermal protection and structural reinforcement. In still another example, the cover is in the form of a tube in which the fuel grain is inserted for a tight fit. Once encased in the cover(s), the fuel grain assembly 801 can be placed into an engine case of a rocket (see FIG. 9). In some examples, the wrapping or tube serves as the engine case.

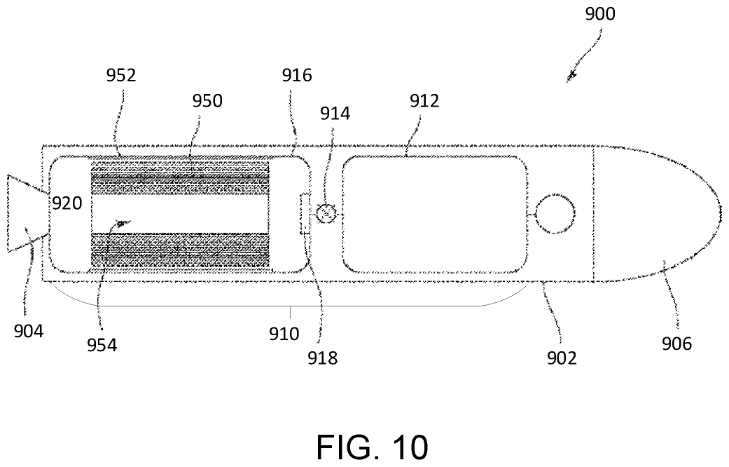

Referring to FIG. 10, an example hybrid rocket engine powered vehicle 900 incorporates a wrapped fuel grain 950 (e.g., any of the fuel grains or the fuel grain assembly described above). In some examples, the fuel grain assembly 900 of multiple fuel grains 100 is used in place of a single fuel grain. The hybrid rocket engine powered vehicle 900 includes a body 902, a nozzle 904 at one end of the body 902, and a payload section 906 at the other end of the body 902. The body 902 houses a hybrid rocket engine 910 that includes an oxidizer tank 912, a valve 914, an engine case 916, and an oxidizer injector 918. The oxidizer injector 918 is housed within a forward cap (not shown) that also houses an ignition system (not shown). The engine case 916 houses a pre-combustion chamber (not shown), a post-combustion chamber 920, and the fuel grain 950 wrapped in a cover 952 or inserted within a tube. Oxidizer from the oxidizer tank 912 is injected into a combustion port 954 of the fuel grain 950, where successive regions of varying composition are exposed to and combusts with the oxidizer, providing the hybrid rocket engine with a thrust and economy composition suited to the flight profile of the hybrid rocket engine powered vehicle 900.

The fuel grains described here can be fabricated by additive manufacturing techniques, such as fused deposition additive manufacturing. In fused deposition additive manufacturing, the fuel grain material, in a viscous state, is extruded from a deposition head of an additive manufacturing system and deposited as beads, which fuse with adjacent beads and solidify to form a fuel grain composed of a stacked set of layers, each layer including fused concentric beads. The concentric beads increase in radius from the inner combustion port wall outward. Concentric beads of different compositions are deposited layer by layer by the additive manufacturing system, thereby creating a fuel grain with a variation (e.g., radial, circumferential, or other geometric variation) in the composition of the concentric beads. In some examples, an additive manufacturing system including multiple deposition heads (e.g., two or more deposition heads) is used to deposit the beads, with each deposition head depositing beads of a different composition. In some examples, a single deposition head is used, with the composition of the fuel grain material that is extruded from the deposition head being varied. Other additive manufacturing techniques can also be used, e.g., sintering, photochemical based curing of optically reactive polymers, or other suitable techniques.

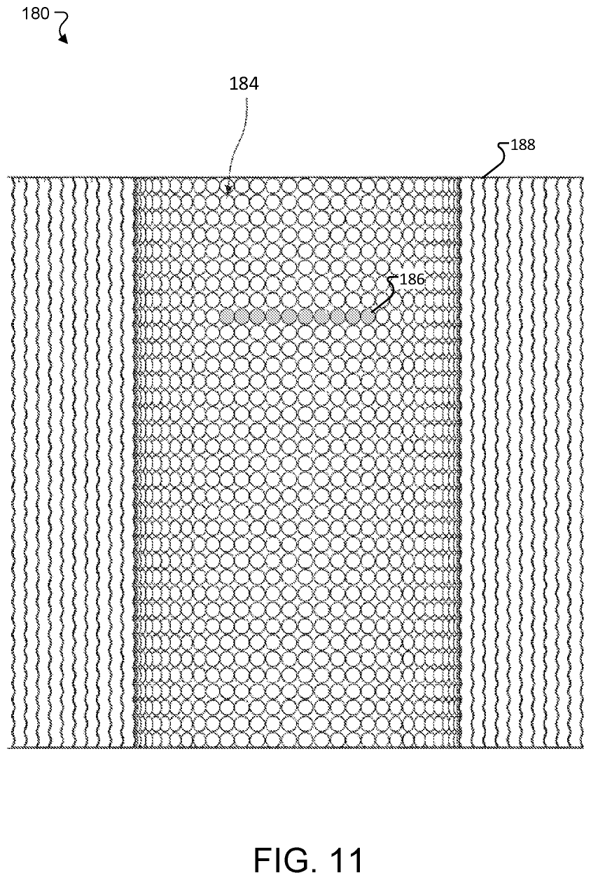

Referring to FIG. 11, in some examples, a fuel grain 180 is fabricated by depositing (e.g., extruding) multiple, adjacent concentric beads 184 each featuring a series of substantially identical curved undulations thus forming small blisters or dimples (e.g., blisters 186 or other similar shapes) which increase fuel surface area. The shaded blisters 186 indicate a portion of a concentric bead 184 in FIG. 11. Multiple, adjacent concentric beads form a layer 188 of the fuel grain 180. Once a completed layer is formed, concentric beads of a larger diameter are deposited on top of the completed layer to form a successive layer of concentric beads. For instance, to form a fuel grain having a radial compositional variation, fused concentric beads are deposited to form the innermost region of the fuel grain possessing a composition featuring a specific energetic release upon combustion, and upon completion of the innermost region, additional concentric beads are deposited to form a region possessing a different energetic release upon combustion.

An additive manufacturing system can depose concentric beads of different compositions to create a fuel grain with a variation (e.g., radial variation) in composition. For instance, the additive manufacturing system can depose concentric beads of a first composition to form a first layer of the fuel grain and beads of a second, different composition to form another layer of the fuel grain.

FIG. 11 shows an additive manufacturing system 700 for use in fabricating a fuel grain with a compositional variation, in which the fuel grain is fabricated in a horizontal orientation. The additive manufacturing system 700 includes an elongated mandrel 702 that serves as a turning substrate onto which axially adjacent concentric beads of fuel grain material are deposited to form a horizontal layer of the fuel grain. Subsequent layers of concentric beads are deposited onto previously-deposited layers. The mandrel 702 is rotatable along its axis (denoted by an arrow 703 in FIG. 11). Rotation of the mandrel 702 is controlled by a rotation mechanism, such as a robotic element or motor, that operates under control of a controller 708. In some examples, the mandrel 702 is coated with a material, such as a low-friction coating or a dissolvable material (e.g., a water-soluble material), to facilitate removal of the finished fuel grain from the mandrel 702. In some examples, the mandrel 702 is a smooth, tubular mandrel for formation of a fuel grain with a cylindrical combustion port (e.g., the fuel grain of FIG. 1). In some examples, the mandrel 702 is a shaped mandrel for formation of a fuel grain with a non-cylindrical vortex inducing combustion port, e.g., as shown in FIG. 4 or 6.

The additive manufacturing system 700 includes two, independently controllable deposition heads 710a, 710b. The deposition heads 710a, 710b can be moved in a direction parallel to the axis of the mandrel 702, in a direction denoted as x in FIG. 11. Motion of the deposition heads 710a, 710b is controlled by a translation mechanism, such as a robotic element, motor, sliding mechanism, or other mechanism, that operates under control of the controller 708. In some examples, the deposition heads 710a, 710b can also be moved closer to or further from the mandrel 702, in a direction denoted as z in FIG. 11, e.g., under control by the controller 708. In some examples, the deposition heads 710a, 710b are stationary and the mandrel is movable relative to the deposition heads 710a, 710b. Although the system 700 is illustrated with two deposition heads, fuel grains having local compositional variations also can be fabricated using systems with more than two deposition heads.

Each deposition head 710a, 710b includes a nozzle 720a, 720b that is connected to a respective source 714a, 714b of fuel grain material. The fuel grain material can be a compounded formulation of a polymer based rocket fuel material (e.g., ABS thermoplastic) and micron-scale or nanoscale metallic material (e.g., nanoscale aluminum particles). The sources 714a, 714b of fuel grain material can contain fuel grain material of different composition (e.g., weight or volume percentage of the additive, size or geometry of the additive, composition of the additive, or composition of the polymer fuel material), such that the plurality of concentric beads forming a layer or a collection of layers forming a region can be fabricated of different composition by the additive manufacturing system 700 to form a fuel grain with a variation (e.g., radial variation) in composition. In some examples, the additive manufacturing system 700 can have more than two deposition heads and thus can depose beads of three or more different compositions, enabling fabrication of a fuel grain with several regions each of distinct composition.

In some examples, each deposition head 710a, 710b can include a second nozzle that is connected to a source of water-soluble disposable material. The second nozzle can be used to deposit the water-soluble material directly onto the mandrel 702 to facilitate removal of the completed fuel grain from the mandrel 702, or to deposit the water-soluble material as appropriate to support structural features in the design of the fuel grain, e.g., to support overhanging structures.

In some examples, the sources 714a, 714b are pellets of fuel grain material that are fed under vacuum to an auger drive that crushes and heats the pellets to a target viscosity, with the viscous material being fed to the deposition heads under pressure. In some examples, the sources 714a, 714b of fuel grain material are cartridges storing spools of fuel grain material. A bead of a first composition can be deposited by extruding the liquefied fuel grain material from the source 714a from the nozzle 720a of the deposition head 710a. A bead of a second composition can be deposited by extruding the liquefied fuel grain material from the source 714b from the nozzle 720b of the deposition head 710b.

In the example shown, multiple, adjacent beads are deposited onto the mandrel 702 adjacent to one another in a direction parallel to the axis of the mandrel to form multiple, adjacent concentric beads 730. Depositing concentric beads onto the mandrel 702 encompasses depositing beads onto a material disposed on the mandrel that facilitates removal of the completed fuel grain, e.g., onto a mandrel coated with a low friction material or onto a mandrel having a dissolvable material disposed thereon. To depose the concentric beads, the mandrel 702 is rotated about its axis during the extrusion and deposition process and the deposition head(s) 710a, 710b are translated along the axis of the mandrel 702 such that each concentric bead is deposited axially adjacent to the previously deposited bead. The rotation of the mandrel 702 is calibrated such that each bead contacts and can fuse with the previously-deposited bead.

When deposition of the concentric beads of the first layer has been completed, a second layer of beads is deposited over the first layer. The concentric beads in the second layer are deposited over the concentric beads in the first layer such that they contact and can fuse with the concentric beads in the first layer. Deposition of successive layers of beads continues until a complete fuel grain has been formed. The first layer, which is formed of concentric beads deposited onto the mandrel 702, forms the initial inner wall of the fuel grain combustion port.

Once deposition of the first layer of the fuel grain is completed, concentric beads are deposited directly onto the first layer to form the next layer of the fuel grain. Each successive layer is concentric with the previously-deposited layer and has a slightly larger diameter, and thus contains more fuel material than the previously-deposited layer. Deposition of each layer proceeds generally as described above for the first layer, except that the beads are deposited onto bead of fuel grain material rather than onto the mandrel 702.

To form two successive layers having concentric beads of the same composition, the same deposition head is used to depose the concentric beads in both layers. To form a first layer with concentric beads of one composition and the next layer with beads of a different composition, thereby creating a radial compositional variation, a different deposition head is used to depose the concentric beads in each layer. For instance, the concentric beads of the first layer can be deposited with the deposition head 710a, and the concentric beads of the next layer can be deposited with the deposition head 710b. To create an axial compositional variation, a portion of a given layer is formed by depositing concentric beads from one deposition head and a different portion of the layer is formed by depositing concentric beads from the other deposition head. Combinations of various geometries of compositional variations can also be achieved, e.g., to form a fuel grain having both an axial and a radial compositional variation.

In a specific example, the additive manufacturing system 700 can be used to fabricate a fuel grain having three radially adjacent regions: an innermost set of layers with beads composed of 25% by weight of the nanoscale metallic material, a middle set of layers with beads composed of 10% by weight of the nanoscale metallic material, and an outermost set of layers with beads composed of 25% by weight of the nanoscale metallic material. The source 714a provides fuel grain material that includes 25% by weight of the nanoscale metallic material, and thus the deposition head 710a is used for deposition of the beads of the innermost and outermost sets of layers. The source 714b provides fuel grain material that includes 10% by weight of the nanoscale metallic material, and thus the deposition head 710b is used for deposition of the beads of the middle set of layers.

The additive manufacturing system 700 can be used to fabricate fuel grains with variation in compositional characteristics other than the weight percentage of the micron-scale or nanoscale metallic material. In an example, the additive manufacturing system 700 can be used to fabricate a fuel grain having two radially adjacent regions: an innermost set of layers with beads composed of 25% by weight of nanoscale metallic material having a diameter of 10 nm and an outermost set of layers with beads composed of 10% by weight of nanoscale metallic material having a diameter of 20 nm. The source 714a provides fuel grain material that includes 25% by weight of 10 nm diameter nanoscale metallic material, and thus the deposition head 710a is used for deposition of the beads of the innermost set of layers. The source 714b provides fuel grain material that includes 10% by weight of the 20 nm nanoscale metallic material, and thus the deposition head 710b is used for deposition of the beads of the outermost set of layers.

The use of multiple deposition heads, each depositing fuel grain material of a different composition, can enable fabrication of a fuel grain in which the composition of the concentric beads varies within a single layer, e.g., axially or circumferentially. A transition region between a set of layers with beads of a first composition and a set of layers with beads of a second composition can be fabricated by depositing layers of beads in which the ratio of beads of the first composition to beads of the second composition gradually decreases across the layers of the transition region.

The additive manufacturing system 700 also enables deposition of concentric beads with different types of additives. For instance, the deposition heads 710a, 710b can be used to depose micron-scale or nanoscale metallic materials of different sizes or compositions.

To create a density variation in the fuel grain using the additive manufacturing system 700, the rate of extrusion of the fuel grain material from one or both deposition heads 710a, 710b can be varied. Extrusion from one or both of the deposition heads 710a, 710b can be pulsed, which results in small gaps in the extruded material that increases the surface area of the fuel grain. Extrusion from a deposition head can be stopped entirely while the mandrel continues to rotate to form macroscale voids.

In some examples, once deposition of the fuel grain material is complete, the additive manufacturing system 700 can be used for deletive machining process steps by changing out the deposition heads with deletive tools. In some examples, previously deposited fuel grain material can be removed, e.g., by burning or in another way, to create macroscale voids or to adjust the geometry of the combustion port. Deletive machining also enables tasks such as machining the ends of the fuel grain to ensure a flush smooth fit to a forward cap and nozzle assembly, lathing the outermost concentric beads to smooth the fuel grain's outer wall to ensure a tight fit within an engine case, or other post-processing tasks.

The additive manufacturing system also can be used for other post-processing tasks such as filament or tape winding placement heads to encase the fuel grain in a cover, such as a coating of a thermally insulating material (e.g., phenol) or a coating of fiber (e.g., carbon fiber). For instance, the fuel grain can be encased in a thermally insulating material, and then an outer fiber casing can be formed around the encased fuel grain. The cover can be applied by contacting the cover to the outer surface of the fuel grain, e.g., affixing an edge of the cover to the outer surface, and rotating the mandrel 702 such that the cover wraps around the fuel grain. Once the fuel grain is encased in the cover, the wrapped fuel grain is removed from the mandrel. Fabricating and wrapping the fuel grain with a single production system provides manufacturing efficiencies, e.g., time and/or cost efficiencies.

In some examples, the wrapped fuel grain is removed from the additive manufacturing system 700 and machined, e.g., milled, to a desired size and to a desired angle (e.g., a 90° angle) between the end and the length of the fuel grain.

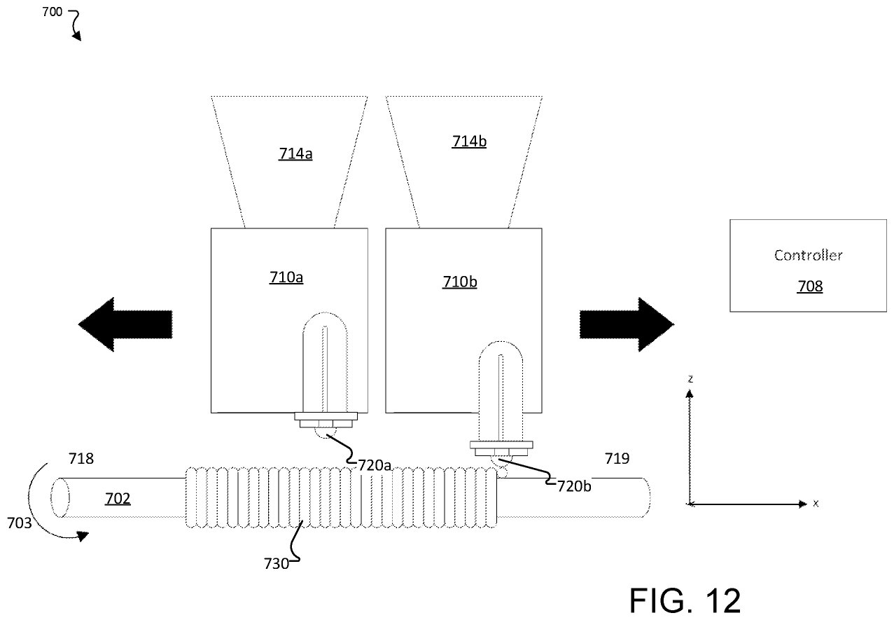

Referring to FIG. 12, an additive manufacturing system 800 for use in fabricating a fuel grain with a compositional variation includes a single deposition head 810 including a nozzle 820. Some elements of the additive manufacturing system 800 are consistent with elements of the additive manufacturing system 700 described above; these elements are not described again with respect to FIG. 8. The single deposition head 810 is connected to a source 814 of polymer based rocket fuel material (e.g., ABS thermoplastic or another suitable polymer material). In some examples, the source 814 is are pellets of fuel grain material that are fed under vacuum to an auger drive that crushes and heats the pellets to a target viscosity, with the viscous material being fed to the deposition heads under pressure. In some examples, the source 814 of polymer based rocket fuel material can be a cartridge storing a spool of ABS thermoplastic.

A source 822 of an additive is connected to the nozzle 820 via a supply channel 824 controlled by a flow controller 826, such as a valve. The amount of the additive injected into the flow channel 820 can be controlled to obtain a desired composition of the fuel grain material at the deposition head 810. For instance, opening the valve 826 to increase the flow rate of the additive through the supply channel 824 increases the weight percentage of the additive in the fuel grain material that is extruded from the deposition head 810.

Multiple concentric beads 830 are deposited using the deposition head 810 to form each of multiple, concentric layers of a fuel grain, e.g., as described above with respect to FIG. 11. The composition of the beads can be varied by controlling the flow rate of the additive. This enables compositional variations to be formed, e.g., from layer to layer (e.g., for a radial compositional variation), within a given layer (e.g., for an axial compositional variation), within a given bead (e.g., for a circumferential compositional variation), or in other geometries. In an example, to fabricate a fuel grain having a radial compositional variation, the flow rate of the additive can be kept constant during deposition of all of the beads in a given set of layers to deposit beads having a first weight percentage of the additive, and then decreased to a lower flow rate during deposition of all of the beads in a subsequent set of layers to deposit beads having a lower weight percentage of the additive. To fabricate a fuel grain having an axial compositional variation, the flow rate of the additive is varied as deposition proceeds along the axis of the fuel grain. To fabricate a fuel grain having a circumferential compositional variation, the flow rate of the additive is varied during deposition of an individual bead. Combinations of various geometries of compositional variations can also be achieved, e.g., to form a fuel grain having both an axial and a radial compositional variation.

In an example, the additive manufacturing system 800 can be used to fabricate a fuel grain having three radially adjacent regions: an innermost set of layers with beads composed of 25% by weight of a nanoscale metallic material, a middle set of layers with beads composed of 10% by weight of the nanoscale metallic material, and an outermost set of layers with beads composed of 20% by weight of the nanoscale metallic material. The flow rate of the nanoscale metallic material is adjusted for deposition of the beads in each set of layers to achieve the respective weight percentage of the nanoscale metallic material.

Using the additive manufacturing system 800, a gradual gradient in the composition of the beads (e.g., radially across the layers of a fuel grain can be achieved by changing (e.g., increasing or decreasing) the flow rate of the additive slightly for each successive layer. For instance, a transition region between a set of layers with beads of a first composition and a set of layers with beads of a second composition can be fabricated by depositing layers of beads in which the weight percentage of the additive increases gradually across the layers of the transition region. Similarly, an axial gradient or circumferential can be achieved by changing the flow rate of the additive as deposition proceeds axially or circumferentially.

In an example, the additive manufacturing system 800 can be used to fabricate a fuel grain having an innermost set of layers with beads composed of 25% by weight of the nanoscale material and an outermost set of layers with beads composed of 5% by weight of the nanoscale material spaced by a transition region of three layers. The flow rate of the nanoscale metallic material can be decreased slightly for each of the layers of the transition region such that the first layer of the transition region has beads composed of 10% by weight of the nanoscale metallic material, the second layer of the transition region has beads composed of 15% by weight of the nanoscale metallic material, and the third layer of the transition region has beads composed of 20% by weight of the nanoscale metallic material.

Density variations can be achieved as discussed for the multiple-head system 700, e.g., by varying the rate of extrusion of the fuel grain material as deposition proceeds radially, axially, or circumferentially. Pulsed deposition can be performed to increase the surface area, and extrusion can be stopped at specific locations to form macroscale voids. In addition, post-processing such as that discussed above for the multiple-head system 700 can be performed.

In some examples, fuel grains with a radial compositional variations can be fabricated using a vertically oriented additive manufacturing system. Vertically oriented additive manufacturing systems can have mandrels to guide deposition, or deposition can be performed without a mandrel. In such a system, multiple concentric beads are deposited at the same axial position (e.g., along a mandrel or as a free-standing element) to form a first ring layer of the fuel grain. The first concentric bead to be deposited has the smallest radius (e.g., is closest to the mandrel, when a mandrel is used); subsequent adjacent concentric beads are concentric with the first concentric bead and having increasing radius. Once the multiple concentric beads of the first ring layer are deposited, subsequent ring layers are deposited. For each ring layer, deposition begins with the innermost concentric bead of the ring layer; subsequent adjacent concentric beads are concentric with the innermost concentric bead and have increasing radius. In this way, the fuel grain is fabricated along its axis, e.g., with the complete thickness of the fuel grain fabricated at one end and proceeding along the axis of the mandrel to finish with fabrication of the complete thickness of the fuel grain at the other end.

A vertically oriented additive manufacturing system can be used to fabricate fuel grains with radial, axial, circumferential, or Cartesian variations in composition, e.g., using a one- or multiple-deposition head system, e.g., as described above for the horizontally oriented systems. Vertically oriented additive manufacturing systems can also be used to fabricate fuel grains with local composition variations, e.g., local macroscale voids.

In some examples, additive manufacturing processes other than extrusion of concentric beads are used to fabricate fuel grains with compositional variations. Generally, the additive manufacturing system operates under control of a computer program, e.g., a G-Code program, that specifies which material are to be deposited in which locations. The computer program can control the additive manufacturing system to depose certain materials in certain locations to obtain a target geometry of compositional variations. The computer program can also control the speed of the deposition, e.g., to create variations in porosity, bead size, or other form variations. In addition, the computer program can control the print orientation and direction to fabricate fuel grains of arbitrary geometries, including cylindrical and non-cylindrical fuel grains, and fuel grains with cylindrical and non-cylindrical combustion ports. For suitable additive manufacturing techniques, the computer program can control the infill pattern, e.g., to achieve a target surface area or amount of porosity.

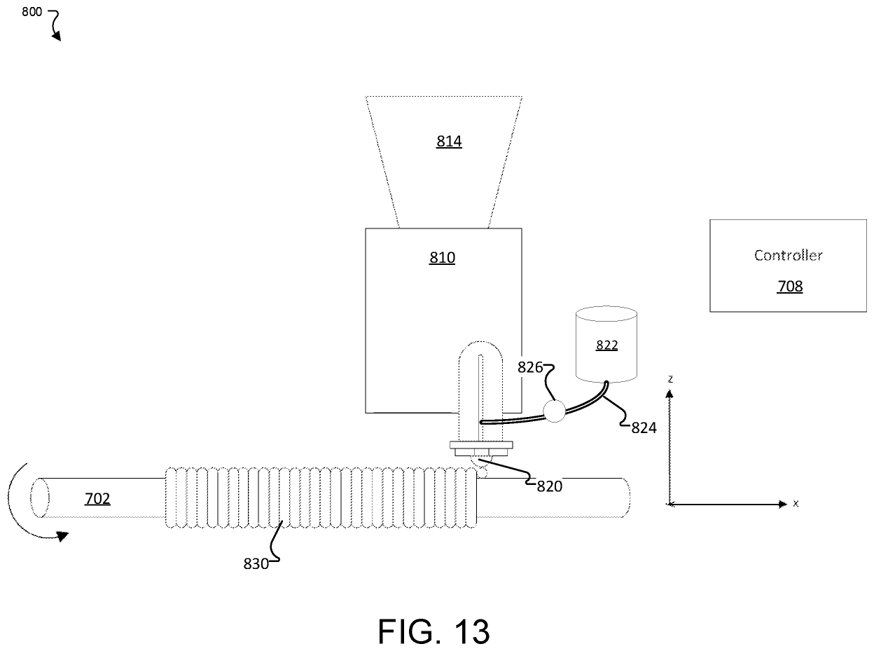

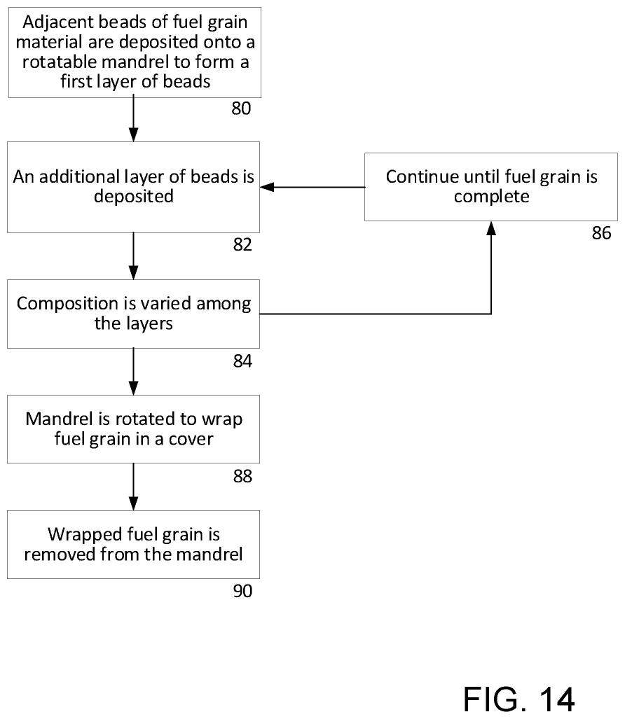

Referring to FIG. 13, in an example process for making a fuel grain with a radial compositional gradient, multiple beads are deposited, by an additive manufacturing technique, adjacent one another around the circumference of a mandrel to form a first layer of beads (80). Each bead extends around the circumference of the mandrel. For instance, the beads are extruded from a deposition head of an additive manufacturing system. The beads are composed of a hybrid rocket fuel material, such as ABS thermoplastic, and a micron-scale or nanoscale metallic material, such as nanoscale aluminum particles.

Multiple, concentric layers of beads are deposited each directly onto the preceding layers of beads, including at least one layer of different composition than the other layers (82). The composition (e.g., weight percentage of the micron-scale or nanoscale metallic material, volume percentage of the micron-scale or nanoscale metallic material, size of the micron-scale or nanoscale metallic material, or composition of the micron-scale or nanoscale metallic material) of the beads is varied between at least two of the layers (84).

In some examples, the beads in all layers are deposited using a single deposition head, and the composition of the material extruded from the deposition head is varied to achieve the radial variation in composition. In some examples, multiple deposition heads are used, each deposition head depositing beads of a different composition.

When the deposition of the beads is complete (86), the fuel grain is wrapped in a cover, such as a thermal cover or a fiber cover, by rotation of the mandrel while the fuel grain is still supported on the mandrel (88). The wrapped fuel grain is removed from the mandrel (90) for use in a hybrid rocket engine.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A method of making a fuel grain for a hybrid rocket engine, the method comprising:
depositing beads of fuel grain material onto a mandrel using additive manufacturing to form a fuel grain, each bead comprising a polymer based rocket fuel material, the depositing comprising:
depositing multiple, adjacent beads to form concentric layers of beads, wherein a composition of the beads of the fuel grain material differs between the beads of a first layer and the beads of a second layer of the fuel grain.

2. The method of claim 1, wherein a composition of the polymer based rocket fuel material differs between the beads of the first layer and the beads of the second layer of the fuel grain.

3. The method of claim 1 or 2, in which at least some of the beads comprise a metallic or polymer additive material.

4. The method of claim 3, comprising depositing the beads such that one or more of a weight percentage of the metallic or polymer additive material, a volume percentage of the metallic or polymer additive material, a shape of the metallic or polymer additive material, or a size of the metallic or polymer additive material in the beads of the fuel grain material differs between the beads of the first layer and the beads of the second layer of the fuel grain.

5. The method of claim 3 or 4, comprising depositing the beads such that a composition of the metallic or polymer additive material differs between the beads of the first layer and the beads of the second layer of the fuel grain.

6. The method of claim any of claims 3 to 5, in which depositing multiple beads comprises deposing beads comprising between 75% and 95% by weight of the polymer based rocket fuel material and between 5% and 25% by weight of the metallic or polymer additive material.

7. The method of claim any of claims 3 to 6, in which the metallic or polymer additive material comprises nanoscale aluminum particles and in which the polymer based rocket fuel material comprises an ABS thermoplastic.

8. The method of claim any of claims 3 to 7, in which the metallic or polymer additive material comprises nanoscale or microscale metal or polymer particles.

9. The method of claim any of claims 3 to 8, comprising depositing the beads such that the beads of an innermost one of the concentric layers have a greater weight percentage of the metallic or polymer additive material than the beads of an outermost one of the concentric layers.

10. The method of claim any of claims 3 to 9, comprising depositing the beads such that the metallic or polymer additive material in the beads of the innermost one of the concentric layers is smaller in size than the metallic or polymer additive material in the beads of an outermost one of the concentric layers.

11. The method of any of the preceding claims, in which depositing the beads of fuel grain material comprises rotating the mandrel during deposition of the beads.

12. The method of any of the preceding claims, comprising depositing the beads using a single deposition head.

13. The method of claim 12, in which in which at least some of the beads comprise a metallic or polymer additive material, and in which depositing each layer of beads comprises changing an amount of the metallic or polymer additive material provided to the single deposition head between deposition of the beads of the first layer and deposition of the beads of the second layer.

14. The method of claim 13, in which changing the amount of the metallic or polymer additive material comprises varying a rate at which the metallic or polymer additive material is injected into the hybrid rocket fuel material.

15. The method of any of the preceding claims, comprising depositing the beads of the first layer using a first deposition head and depositing the beads of the second layer using a second deposition head.

16. The method of claim 15, comprising supplying a first composition of fuel grain material to the first deposition head and a second composition of fuel grain material to the second deposition head.

17. The method of any of the preceding claims, comprising encasing the fuel grain in a cover without removing the fuel grain from the mandrel.

18. The method of claim 17, comprising rotating the mandrel to encase the fuel grain in the cover.

19. The method of any of the preceding claims, comprising varying an extrusion rate of the fuel grain material during the depositing.

20. The method of any of the preceding claims, comprising stopping the depositing to define a void in the fuel grain.

21. The method of claim 20, comprising disposing a second material into the void.

22. The method of claim 21, in which the second material comprises one or more of a solid propellant or a high thermal conductivity material.

23. The method of claim 21 or 22, comprising disposing the second material into the void using a manufacturing technique other than the additive manufacturing used to depose the beads of the fuel grain material.

24. A method of making a fuel grain for a hybrid rocket engine, the method comprising:
depositing multiple beads of fuel grain material adjacent to one another to form a fuel grain defining a combustion port extending axially therethrough, each bead of fuel grain material comprising a polymer based rocket fuel material,
in which the depositing includes depositing beads of different form, beads of different composition, or both, such that the composition of the fuel grain varies within the fuel grain.

25. The method of claim 24, comprising depositing beads of different form, beads of different composition, or both such that the composition of the fuel grain varies along a radius of the fuel grain.

26. The method of claim 24 or 25, comprising depositing beads of different form, beads of different composition, or both such that the composition of the fuel grain varies along an axis of the fuel grain.

27. The method of any of claims 24 to 26, comprising depositing beads of different form, beads of different composition, or both such that the composition of the fuel grain varies around a circumference of the fuel grain.

28. The method of any of claims 24 to 27, comprising depositing beads of different form, beads of different composition, or both such that the composition of the fuel grain at a first location in the fuel grain differs from the composition of the fuel grain at a second location in the fuel grain.

29. The method of any of claims 24 to 28, in which at least some of the beads comprise a metallic or polymer additive material.

30. The method of claim 29, in which depositing beads of different composition comprises depositing beads having a difference in one or more a weight percentage of the metallic or polymer additive material, a volume percentage of the metallic or polymer additive material, a shape of the metallic or polymer additive material, or a size of the metallic or polymer additive material.

31. The method of claim 29 or 30, in which depositing beads of different composition comprises depositing beads having a difference in a composition of the metallic or polymer additive material.

32. The method of any of claims 24 to 31, in which depositing beads of different composition comprises depositing beads having a difference in a composition of the polymer based rocket fuel material.

33. The method of claim 32, in which depositing beads having a difference in a composition of the polymer based rocket fuel material comprises depositing a first bead having a first polymer based rocket fuel material and depositing a second bead having a second polymer based rocket fuel material.

34. The method of claim 32 or 33, in which depositing beads having a difference in a composition of the polymer based rocket fuel material comprises depositing beads composed of a blend of multiple polymer based rocket fuel materials, comprising depositing a first bead having a first blend of the multiple polymer based rocket fuel materials and depositing a second bead having a second nd of the multiple polymer based rocket fuel materials.

35. The method of any of claims 24 to 34, in which depositing multiple beads of fuel grain material comprises extruding the beads of fuel grain material from a nozzle of an additive manufacturing system.

36. The method of any of claims 24 to 35, in which depositing beads of different composition comprises:
depositing beads of a first composition to form a first region of the fuel grain; and
depositing beads of a second composition to form a second region of the fuel grain.

37. The method of claim 36, in which the first region is concentric with the second region.

38. The method of claim 36 or 37, in which the first region is adjacent to the second region along an axis of the fuel grain.

39. The method of any of claims 36 to 38, comprising:
depositing the beads of the first composition using a first deposition head; and
depositing the beads of the second composition using a second deposition device.

40. The method of any of claims 36 to 38, comprising depositing the beads of the first composition and the beads of the second composition using a single deposition head.

41. The method of claim 40, in which at least some of the beads comprise a metallic or polymer additive material, and in which depositing beads of the first and second composition comprises varying an amount of the metallic or polymer additive material provided to a nozzle of the single deposition head.

42. The method of any of claims 24 to 41, in which depositing multiple beads of fuel grain material comprises depositing multiple adjacent beads in a direction parallel to the axial length of the fuel grain to form a first layer of beads.

43. The method of claim 42, in which depositing multiple beads of fuel grain material comprises forming a second layer of beads by depositing beads onto the first layer of beads,
in which the first layer of beads forms an inner wall of the fuel grain, the inner wall defining the combustion port of the fuel grain.

44. The method of claim 43, in which depositing multiple beads of fuel grain material comprises forming multiple additional layers, and in which the composition of the beads of one of the additional layers of beads differs from the composition of the beads of another one of the additional layers of beads.

45. The method of any of claims 24 to 44, comprising varying an extrusion rate of the fuel grain material during the depositing.

46. The method of any of claims 24 to 45, comprising stopping the depositing to define a void in the fuel grain.

47. The method of claim 46, comprising disposing a second material into the void.

48. The method of claim 47, in which the second material comprises one or more of a solid propellant or a high thermal conductivity material.

49. A fuel grain for a hybrid rocket engine, the fuel grain comprising:
multiple, concentric layers of fuel grain material defining a combustion port extending through a body of the fuel grain, in which each layer comprises multiple beads of fuel grain material, in which the multiple beads in a given layer are disposed adjacent to one another and bonded together, and in which adjacent concentric layers are bonded together,
in which each bead of fuel grain material comprises a polymer based rocket fuel material, and in which a composition of the fuel grain material varies along a radius of the fuel grain.

50. The fuel grain of claim 49, in which at least some of the beads comprise a metallic or polymer additive material.

51. The fuel grain of claim 50, in which the metallic or polymer additive material comprises nanoscale or microscale metal or polymer particles.

52. The fuel grain of claim 51, in which the metallic or polymer additive material comprises nanoscale aluminum particles.

53. The fuel grain of claim 52, in which the nanoscale aluminum particles are passivated with a polymer.

54. The fuel grain of claim 52 or 53, in which the nanoscale aluminum particles have an average diameter of between 5 nm and 20 nm.

55. The fuel grain of any of claims 50 to 54, in which one or more of a weight percentage of the metallic or polymer additive material or a volume percentage of the metallic or polymer additive material in the beads of the fuel grain material varies along the radius of the fuel grain.

56. The fuel grain of claim 55, in which the weight percentage or volume percentage of the metallic or polymer additive material in the beads of the fuel grain material varies monotonically from an inner wall to an outer wall of the fuel grain, the inner wall of the fuel grain defining the combustion port.

57. The fuel grain of any of claims 50 to 56, in which a size or shape of the metallic or polymer additive material in the beads of the fuel grain material varies along the radius of the fuel grain.

58. The fuel grain of any of claims 50 to 57, in which a composition of the metallic or polymer additive material in the beads of the fuel grain material varies along the radius of the fuel grain.

59. The fuel grain of any of claims 50 to 58, in which the fuel grain material comprises between 75% and 95% by weight of the polymer based rocket fuel material and between 5% and 25% by weight of the metallic or polymer additive material.

60. The fuel grain of any of claims 49 to 59, in which a composition of the polymer based rocket fuel material varies along the radius of the fuel grain.

61. The fuel grain of any of claims 49 to 60, in which a density of the fuel grain material varies along the radius of the fuel grain.

62. The fuel grain of any of claims 49 to 61, in which the composition of the beads of the fuel grain material in a first region of the fuel grain differs from the composition of the beads of the fuel grain material in a second region of the fuel grain, and in which the first and second regions are adjacent to one another along the radius of the fuel grain.

63. The fuel grain of claim 62, in which the first and second regions each comprise multiple concentric layers of beads.

64. The fuel grain of claim 63, in which at least one of the concentric layers comprises beads of multiple compositions.

65. The fuel grain of claim 63 or 64, in which at least some of the beads comprise a metallic or polymer additive material, and in which the beads an innermost one of the concentric layers have a greater weight percentage of the metallic or polymer additive material or greater volume percentage of the metallic or polymer additive material, as compared to the beads of an outermost one of the concentric layers.

66. The fuel grain of any of claims 63 to 65, in which at least some of the beads comprise a metallic or polymer additive material, and in which the metallic or polymer additive material in the beads of an innermost one of the concentric layers are smaller in size than the metallic or polymer additive material in the beads of an outermost one of the concentric layers.

67. The fuel grain of any of claims 49 to 66, in which the composition of a first bead of the fuel grain material differs from the composition of a second bead adjacent to the first bead.

68. The fuel grain of any of claims 49 to 67, in which the hybrid rocket fuel material comprises an Acrylonitrile Butadiene Styrene (ABS) thermoplastic.

69. The fuel grain of any of claims 49 to 68, in which an inner wall of the fuel grain is textured, the inner wall defining the combustion port.

70. The fuel grain of claim 69, in which the fuel grain is configured such that when the inner wall of the fuel grain ablates due to combustion in the combustion port, a new textured surface of the fuel grain is exposed to the combustion port.

71. The fuel grain of claim 69 or 70, in which the inner wall of the fuel grain is composed of beads of the fuel grain material.

72. The fuel grain of any of claims 49 to 71, in which the fuel grain is fabricated in a freeform fabrication process.

73. The fuel grain of any of claims 49 to 72, in which the beads are fabricated in an extrusion process.

74. The fuel grain of any of claims 49 to 73, comprising a thermally insulating material or a fiber encasing the fuel grain.

75. The fuel grain of any of claims 49 to 74, in which a void is defined in the body of the fuel grain.

76. The fuel grain of claim 75, in which a second material is disposed in the void.

77. The fuel grain of claim 76, in which the second material comprises one or more of a solid propellant or a high thermal conductivity material.

78. A hybrid rocket engine comprising:
a fuel grain comprising multiple, concentric layers of fuel grain material defining a combustion port extending through the fuel grain, in which each layer comprises multiple beads of fuel grain material, in which the multiple beads in a given layer are disposed adjacent to one another and bonded together, and in which adjacent concentric layers are bonded together, in which each bead of fuel grain material comprises a polymer based rocket fuel material and a metallic or polymer additive material,
and in which a composition of the beads of the fuel grain material varies along a radius of the fuel grain;
an oxidizer source configured to provide a flow of an oxidizer through the combustion port during operation of the hybrid rocket engine;
a valve configured to control the flow of the oxidizer through the combustion port;
a nozzle in fluid communication with the combustion port; and
a casing, in which the fuel grain, the oxidizer source, and the valve are housed within the casing, and in which the nozzle extends beyond an end of the casing.

79. A fuel grain for a hybrid rocket engine, the fuel grain comprising:
multiple layers of fuel grain material defining a combustion port extending through a body of the fuel grain, in which each layer comprises multiple beads of fuel grain material, in which the multiple beads in a given layer are disposed adjacent to one another and bonded together, and in which adjacent layers are bonded together,
in which each bead of fuel grain material comprises a polymer based rocket fuel material, and
in which a composition of the beads of the fuel grain material, a form of the beads of fuel grain material, or both varies within the fuel grain.

80. The fuel grain of claim 79, in which the composition of the beads of the fuel grain material, a form of the beads of fuel grain material, or both varies along a radius of the fuel grain.

81. The fuel grain of claim 79 or 80, in which the composition of the beads of the fuel grain material, a form of the beads of fuel grain material, or both varies along an axis of the fuel grain.

82. The fuel grain of any of claims 79 to 81, in which the composition of the beads of the fuel grain material, a form of the beads of fuel grain material, or both varies around a circumference of the fuel grain.

83. The fuel grain of any of claims 79 to 82, in which the composition of the fuel grain at a first location in the fuel grain differs from the composition of the fuel grain at a second location in the fuel grain.

84. The method of any of claims 79 to 83, in which at least some of the beads comprise a metallic or polymer additive material.

85. The fuel grain of claim 84, in which one or more a weight percentage of the metallic or polymer additive material, a volume percentage of the metallic or polymer additive material, a shape of the metallic or polymer additive material, or a size of the metallic or polymer additive material varies within the fuel grain.

86. The fuel grain of claim 84 or 85, in which a composition of the metallic or polymer additive material varies within the fuel grain.

87. The fuel grain of any of claims 84 to 86, in which the metallic or polymer additive material comprises nanoscale or microscale metal or polymer particles.

88. The fuel grain of any of claims 79 to 87, in which a composition of the polymer based rocket fuel varies within the fuel grain.

89. The fuel grain of any of claims 79 to 88, in which a density of the fuel grain material varies within the fuel grain.

90. The fuel grain of any of claims 79 to 89, in which a void is defined in the body of the fuel grain.

91. The fuel grain of claim 90, in which a second material is disposed in the void.

92. The fuel grain of claim 91, in which the second material comprises one or more of a solid propellant or a high thermal conductivity material.

93. The fuel grain of any of claims 79 to 92, in which an inner wall of the fuel grain is textured, the inner wall defining the combustion port.

94. The fuel grain of claim 92, in which the fuel grain is configured such that when the inner wall of the fuel grain ablates due to combustion in the combustion port, a new textured surface of the fuel grain is exposed to the combustion port.
